(19) United States
(12) Patent Application Publication
(10) Pub. No.: US 2025/0162379 A1
(43) Pub. Date: May 22, 2025

(54) CABIN COOLING/HEATING SYSTEM FOR A VEHICLE

(71) Applicants: HYUNDAI MOTOR COMPANY, Seoul (KR); KIA CORPORATION, Seoul (KR); DOOWON HEAVY INDUSTRIAL CO., LTD., Sacheon-si (KR)

(72) Inventors: Yeong Jun Kim, Incheon (KR); Hochan An, Hwaseong-si (KR); Yeonho Kim, Seoul (KR); Jeawan Kim, Hwaseong-si (KR); Gwi Taek Kim, Cheonan-si (KR); Man Hee Park, Suwon-si (KR); Jae Yeon Kim, Hwaseong-si (KR); Hoyoung Jeong, Hwaseong-si (KR); Yun Ki Kwon, Seoul (KR); Jeong Bin Moon, Anseong-si (KR); Tea Jin Lee, Pyeongtaek-si (KR)

(73) Assignees: HYUNDAI MOTOR COMPANY, Seoul (KR); KIA CORPORATION, Seoul (KR); DOOWON HEAVY INDUSTRIAL CO., LTD., Sacheon-si (KR)

(21) Appl. No.: 18/676,600

(22) Filed: May 29, 2024

(30) Foreign Application Priority Data
Nov. 16, 2023 (KR) 10-2023-0158985

(51) Int. Cl. B60H 1/00

(52) U.S. Cl. CPC B60H 1/00899; B60H 1/00885; B60H 2001/00307

(57) ABSTRACT

A cabin cooling/heating system for a vehicle includes: a heat pump system to provide cold or hot water by circulating a refrigerant; an air conditioning device fluidly connected to the heat pump system, configured to receive the cold or hot water from the heat pump system, provide cold or warm air by exchanging heat between inside or outside air of the vehicle and the cold or hot water, and blow the cold air or the warm air to the front cabin; a floor heat exchanger to receive the cold or hot water from the air conditioning device, and configured to cool or heat a cabin floor by circulating the cold or hot water through the cabin floor; and a line switching valve module configured to send the cold or hot water to the floor heat exchanger or return the cold or hot water back to the heat pump system.

### CROSS-REFERENCE TO RELATED APPLICATION

This application claims priority to and the benefit of Korean Patent Application No. 10-2023-0158985 filed in the Korean Intellectual Property Office on Nov. 16, 2023, the entire contents of which are incorporated herein by reference.

### BACKGROUND

### (a) Field

The present disclosure relates to a cabin cooling/heating system for a vehicle. More particularly, the present disclosure relates to a cabin cooling/heating system for a vehicle, which is capable of improving fast-acting cooling/heating properties and quickly reducing a cabin temperature difference.

### (b) Description of the Related Art

In general, an air conditioning device for a vehicle refers to a device embedded in the vehicle and provided to cool or heat a vehicle cabin in the summer or winter seasons. Additionally, an air conditioning device may be provided to remove frost or the like formed on a windshield in rainy weather or winter season to allow a driver to ensure a front/rear visual field. The air conditioning device typically has both a heating system and a cooling system and cools or heats the vehicle cabin by selectively introducing outside air or inside air of the vehicle, heating or cooling the air, and then blowing the air into the vehicle cabin.

In general, the air conditioning device for a vehicle cools or heats the vehicle cabin by blowing cold air or warm air, which is generated by using a heat pump, into the vehicle cabin through an air vent. However, the air may not circulate smoothly because of various obstacles such as air vent positions, vehicle seats, and passengers, which may cause a significant temperature difference between cabin positions during an initial cooling/heating process. In particular, a temperature in a rear seat may be very high or low.

In order to compensate for cabin temperature imbalance during the initial cooling/heating process described above, a seat, a crash pad, a door, and the like are equipped with heating wires, radiant warmers, thermoelectric elements, and the like. However, the heating wires, the radiant warmers, and the thermoelectric elements have low energy efficiency, which may increase electric power consumption and shorten a traveling distance of an environmentally friendly vehicle.

With the development of autonomous driving technology and the proliferation of purpose-built vehicles, the region of the vehicle cabin is increasingly used as an office space, a rest space, a play space, and the like. Thus, a vehicle cabin space gradually increases. Therefore, there is a rapidly increasing need to improve fast-acting cooling/heating properties of the vehicle and eliminate the cabin temperature imbalance during the initial cooling/heating process.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a cabin cooling/heating system for a vehicle, which is capable of implementing a function of cooling or heating a cabin floor of the vehicle. This is achieved by using an air conditioning device for cooling or heating a cabin. As a result, the cabin cooling/heating system improves fast-acting cooling/heating properties and quickly uniformizes a cabin temperature.

According to the embodiment of the present disclosure, a cabin cooling/heating system for a vehicle is disclosed. The vehicle includes therein a front cabin, a rear cabin, and a cabin floor that is a floor of the rear cabin. The cabin cooling/heating system for a vehicle may include: a heat pump system configured to provide cold or hot water by circulating a refrigerant; and an air conditioning device fluidly connected to the heat pump system. The air conditioning device may be configured to receive the cold or hot water from the heat pump system, provide cold or warm air by exchanging heat between inside air or outside air of the vehicle and the cold or hot water, and blow the cold air or the warm air to the front cabin. The cabin cooling/heating system may further include: a floor heat exchanger mounted in the cabin floor, fluidly connected to the air conditioning device, configured to receive the cold or hot water from the air conditioning device, and configured to cool or heat the cabin floor by circulating the cold or hot water through the cabin floor; and a line switching valve module disposed between the air conditioning device and the floor heat exchanger and configured to send the cold or hot water, which has passed through the air conditioning device, to the floor heat exchanger or return the cold or hot water back to the heat pump system. The cold or hot water, which has circulated through the floor heat exchanger, may return back to the heat pump system.

The cabin cooling/heating system for a vehicle may further include a water pump module fluidly connected to the heat pump system and configured to pump the cold or hot water in the heat pump system.

The heat pump system may include: a heat pump heat exchanger configured to provide the cold or hot water by allowing water to exchange heat with the refrigerant; and a heat pump configured to provide the hot water by supplying thermal energy to the water in the heat pump heat exchanger by circulating the refrigerant via a refrigerant circulation line or provide the cold water by recovering thermal energy from the water in the heat pump heat exchanger. The air conditioning device may include an air passageway configured to allow the inside air or the outside air of the vehicle to communicate with the front cabin. The air passageway may define a passageway through which the inside air or the outside air of the vehicle flows to the front cabin. The air conditioning device may further include: an air blower configured to blow the inside air or the outside air of the vehicle into the air passageway; a heater core disposed in the air passageway and configured to receive the hot water from the heat pump heat exchanger and heat the inside air or the outside air of the vehicle in the air passageway; and a cooler disposed in the air passageway and configured to receive the cold water from the heat pump heat exchanger and cool the inside air or the outside air of the vehicle in the air passageway. The line switching valve module may include: a first line switching valve fluidly connected to the heater core and configured to receive the hot water from the heater core and selectively send the hot water to the floor heat exchanger or the heat pump heat exchanger; and a second line switching valve fluidly connected to the cooler and configured to receive the cold water from the cooler and selectively send the cold water to the floor heat exchanger or the heat pump heat exchanger.

The air conditioning device may further include an air door configured to selectively open or close the air passageway through which the inside air or the outside air of the vehicle flows to the heater core.

The air conditioning device may cool or heat the front cabin in response to an operation of the cabin cooling/heating system for a vehicle. Additionally, whether to cool or heat the cabin floor by the floor heat exchanger may be controlled by the line switching valve module.

A cabin cooling/heating system for a vehicle according to another embodiment of the present disclosure includes: a heat pump system configured to provide cold or hot water by circulating a refrigerant; and an air conditioning device fluidly connected to the heat pump system. The air conditioning device may be configured to receive the cold or hot water from the heat pump system, provide cold or warm air by exchanging heat between inside air or outside air of the vehicle and the cold or hot water, and blow the cold air or the warm air to the front cabin. The cabin cooling/heating system may also include a second air conditioning device fluidly connected to the air conditioning device. The second air conditioning device may be configured to receive the cold or hot water from the air conditioning device, provide the cold or warm air by exchanging heat between the inside air or the outside air of the vehicle and the cold or hot water, and blow the cold air or the warm air to the rear cabin. The cabin cooling/heating system may also include a floor heat exchanger mounted in the cabin floor. The floor heat exchanger may be fluidly connected to the second air conditioning device, and configured to receive the cold or hot water from the second air conditioning device, and cool or heat the cabin floor by circulating the cold or hot water through the cabin floor. Additionally, the cabin cooling/heating system may also include a line switching valve module disposed between the second air conditioning device and the floor heat exchanger. The line switching valve module may be configured to send the cold or hot water, which has passed through the second air conditioning device, to the floor heat exchanger or return the cold or hot water back to the heat pump system. The cold or hot water, which has circulated through the floor heat exchanger, may return back to the heat pump system.

The cabin cooling/heating system for a vehicle may further include a water pump module fluidly connected to the heat pump system and configured to pump the cold or hot water to the heat pump system.

The heat pump system may include: a heat pump heat exchanger configured to provide the cold or hot water by allowing water to exchange heat with the refrigerant; and a heat pump configured to provide the hot water by supplying thermal energy to the water in the heat pump heat exchanger by circulating the refrigerant through a refrigerant circulation line, or configured to provide the cold water by recovering thermal energy from the water in the heat pump heat exchanger. The air conditioning device may include an air passageway configured to allow the inside air or the outside air of the vehicle to communicate with the front cabin. The air passageway may define a passageway through which the inside air or the outside air of the vehicle flows to the front cabin. The air conditioning device may also include: an air blower configured to blow the inside air or the outside air of the vehicle into the air passageway; a heater core disposed in the air passageway and configured to receive the hot water from the heat pump heat exchanger and heat the inside air or the outside air of the vehicle in the air passageway; and a cooler disposed in the air passageway and configured to receive the cold water from the heat pump heat exchanger and cool the inside air or the outside air of the vehicle in the air passageway. The second air conditioning device may include a second air passageway configured to allow the inside air or the outside air of the vehicle to communicate with the rear cabin. The second air passageway may define a passageway through which the inside air or the outside air of the vehicle flows to the rear cabin. The second air conditioning device may include: a second air blower configured to blow the inside air or the outside air of the vehicle into the second air passageway; a second heater core disposed in the second air passageway and configured to receive the hot water from the heater core and heat the inside air or the outside air of the vehicle in the second air passageway; and a second cooler disposed in the second air passageway and configured to receive the cold water from the cooler and cool the inside air or the outside air of the vehicle in the second air passageway. The line switching valve module may include: a first line switching valve fluidly connected to the second heater core and configured to receive the hot water from the second heater core and selectively send the hot water to the floor heat exchanger or the heat pump heat exchanger; and a second line switching valve fluidly connected to the second cooler and configured to receive the cold water from the second cooler and selectively send the cold water to the floor heat exchanger or the heat pump heat exchanger.

The air conditioning device may further include an air door configured to selectively open or close the air passageway through which the inside air or the outside air of the vehicle flows to the heater core. The second air conditioning device may further include a second air door configured to selectively open or close the second air passageway through which the inside air or the outside air of the vehicle flows to the second heater core.

The second air conditioning device may communicate with the air conditioning device, and the rear cabin may be cooled or heated when the second air blower operates.

The air conditioning device may cool or heat the front cabin in response to an operation of the cabin cooling/heating system for a vehicle. Additionally, whether to cool or heat the cabin floor by the floor heat exchanger may be controlled by the line switching valve module.

A cabin cooling/heating system for a vehicle according to still another embodiment of the present disclosure includes: a heat pump system configured to provide cold or hot water by circulating a refrigerant; and an air conditioning device fluidly connected to the heat pump system. The air conditioning device may be configured to receive the cold or hot water from the heat pump system, provide cold or warm air by exchanging heat between inside air or outside air of the vehicle and the cold or hot water, and blow the cold air or the warm air to the front cabin. The cabin cooling/heating system may also include a second air conditioning device fluidly connected to the heat pump system. The second air conditioning device may be configured to receive the cold or hot water from the heat pump system, provide the cold or warm air by exchanging heat between the inside air or the outside air of the vehicle and the cold or hot water, and blow the cold air or the warm air to the rear cabin. The cabin cooling/heating system may also include a floor heat exchanger mounted in the cabin floor, and fluidly connected to the second air conditioning device. The floor heat exchanger may be configured to receive the cold or hot water from the second air conditioning device and cool or heat the cabin floor by circulating the cold or hot water through the cabin floor. The cabin cooling/heating system may also include a line switching valve module disposed between the second air conditioning device and the floor heat exchanger and configured to send the cold or hot water, which has passed through the second air conditioning device, to the floor heat exchanger or return the cold or hot water back to the heat pump system. The cold or hot water, which has circulated through the floor heat exchanger, may return back to the heat pump system.

The cabin cooling/heating system may further include a line addition valve module configured to selectively connect the heat pump system to the second air conditioning device.

The cabin cooling/heating system for a vehicle may further include a water pump module fluidly connected to the heat pump system and configured to pump the cold or hot water in the heat pump system.

The heat pump system may include: a heat pump heat exchanger configured to provide the cold or hot water by allowing water to exchange heat with the refrigerant; and a heat pump configured to provide the hot water by supplying thermal energy to the water in the heat pump heat exchanger by circulating the refrigerant through a refrigerant circulation line or provide the cold water by recovering thermal energy from the water in the heat pump heat exchanger. The air conditioning device may include an air passageway configured to allow the inside air or the outside air of the vehicle to communicate with the front cabin. The air passageway may define a passageway through which the inside air or the outside air of the vehicle flows to the front cabin. The air conditioning device may also include: an air blower configured to blow the inside air or the outside air of the vehicle into the air passageway; a heater core disposed in the air passageway and configured to receive the hot water from the heat pump heat exchanger and heat the inside air or the outside air of the vehicle in the air passageway; and a cooler disposed in the air passageway and configured to receive the cold water from the heat pump heat exchanger and cool the inside air or the outside air of the vehicle in the air passageway. The second air conditioning device may include a second air passageway configured to allow the inside air or the outside air of the vehicle to communicate with the rear cabin. The second air passageway may define a passageway through which the inside air or the outside air of the vehicle flows to the rear cabin. The second air conditioning device may also include: a second air blower configured to blow the inside air or the outside air of the vehicle into the second air passageway; a second heater core disposed in the second air passageway and configured to heat the inside air or the outside air of the vehicle in the second air passageway; and a second cooler disposed in the second air passageway and configured to cool the inside air or the outside air of the vehicle in the second air passageway. The line addition valve module may include: a first line addition valve configured to selectively connect the heater core to the second heater core to selectively supply the hot water in the heater core to the second heater core; and a second line addition valve configured to selectively connect the cooler to the second cooler to selectively supply the cold water in the cooler to the second cooler. The line switching valve module may include: a first line switching valve fluidly connected to the second heater core and configured to receive the hot water from the second heater core and selectively send the hot water to the floor heat exchanger or the heat pump heat exchanger; and a second line switching valve fluidly connected to the second cooler and configured to receive the cold water from the second cooler and selectively send the cold water to the floor heat exchanger or the heat pump heat exchanger.

The air conditioning device may further include an air door configured to selectively open or close the air passageway through which the inside air or the outside air of the vehicle flows to the heater core. Additionally, the second air conditioning device may further include a second air door configured to selectively open or close the second air passageway through which the inside air or the outside air of the vehicle flows to the second heater core.

The air conditioning device may cool or heat the front cabin in response to an operation of the cabin cooling/heating system for a vehicle. Additionally, whether to cool or heat the rear cabin by the second air conditioning device may be controlled by the line addition valve module. Furthermore, whether to cool or heat the cabin floor by the floor heat exchanger may be controlled by the line switching valve module.

According to the present disclosure, the hot or cold water prepared by the heat pump system may be supplied to not only the air conditioning device for cooling or heating the cabin but also to the heat exchanger for cooling or heating the cabin floor. As a result, the heat pump system may simultaneously cool or heat the cabin by using the air conditioning device and cooling or heating the cabin floor by using the heat exchanger. Therefore, it is possible to ensure the cooling/heating performance and the fast-acting properties.

In addition, it is possible to quickly uniformize the cabin temperature distribution by cooling or heating the cabin by using the air conditioning device and cooling or heating the cabin floor by using the heat exchanger.

Furthermore, it is possible to improve comfort in the cabin by cooling or heating the cabin floor and to expand the use of the cabin space.

In addition, the cooling or heating process may be implemented by the heat pump system, thereby improving energy efficiency. Therefore, the amount of electric power consumption may decrease, and the traveling distance may increase.

Other effects, which may be obtained or expected by the embodiments of the present disclosure, are directly or implicitly disclosed in the detailed description of the embodiments of the present disclosure. In other words, various effects expected according to the embodiments of the present disclosure are disclosed in the detailed description described below.

### BRIEF DESCRIPTION OF THE DRAWINGS

The embodiments in the present disclosure may be better understood with reference to the following description in conjunction with the accompanying drawings in which similar reference numerals indicate the same or functionally similar elements.

FIG. 1 is a schematic view of a vehicle equipped with a cabin cooling/heating system for a vehicle according to an embodiment of the present disclosure.

FIG. 2 is a schematic block diagram of a cabin cooling/heating system for a vehicle according to an embodiment of the present disclosure.

FIG. 3 is a schematic block diagram illustrating a case in which an air conditioning device of a cabin cooling/heating system for a vehicle according to an embodiment of the present disclosure is used to cool or heat a cabin.

FIG. 4 is a schematic block diagram illustrating a case in which an air conditioning device of a cabin cooling/heating system for a vehicle according to an embodiment of the present disclosure is used to heat a cabin.

FIG. 5 is a schematic block diagram illustrating a case in which an air conditioning device of a cabin cooling/heating system for a vehicle according to an embodiment of the present disclosure is used to cool a cabin.

FIG. 6 is a schematic block diagram illustrating a case in which an air conditioning device of a cabin cooling/heating system for a vehicle according to an embodiment of the present disclosure is used to cool or heat a cabin, and a floor heat exchanger is used to cool or heat a cabin floor.

FIG. 7 is a schematic block diagram illustrating a case in which an air conditioning device of a cabin cooling/heating system for a vehicle according to an embodiment of the present disclosure is used to heat a cabin, and a floor heat exchanger is used to heat a cabin floor.

FIG. 8 is a schematic block diagram illustrating a case in which an air conditioning device of a cabin cooling/heating system for a vehicle according to an embodiment of the present disclosure is used to cool a cabin, and a floor heat exchanger is used to cool a cabin floor.

FIG. 9 is a schematic view of a vehicle equipped with a cabin cooling/heating system for a vehicle according to another embodiment of the present disclosure.

FIG. 10 is a schematic block diagram of a cabin cooling/heating system for a vehicle according to another embodiment of the present disclosure.

FIG. 11 is a schematic block diagram illustrating a case in which an air conditioning device of a cabin cooling/heating system for a vehicle according to another embodiment of the present disclosure is used to cool or heat a cabin.

FIG. 12 is a schematic block diagram illustrating a case in which an air conditioning device of a cabin cooling/heating system for a vehicle according to another embodiment of the present disclosure is used to cool a cabin.

FIG. 13 is a schematic block diagram illustrating a case in which an air conditioning device of a cabin cooling/heating system for a vehicle according to another embodiment of the present disclosure is used to heat a cabin.

FIG. 14 is a schematic block diagram illustrating a case in which a first air conditioning device and a second air conditioning device of a cabin cooling/heating system for a vehicle according to another embodiment of the present disclosure are used to cool or heat a cabin.

FIG. 15 is a schematic block diagram illustrating a case in which a first air conditioning device and a second air conditioning device of a cabin cooling/heating system for a vehicle according to another embodiment of the present disclosure are used to cool a cabin.

FIG. 16 is a schematic block diagram illustrating a case in which a first air conditioning device and a second air conditioning device of a cabin cooling/heating system for a vehicle according to another embodiment of the present disclosure are used to heat a cabin.

FIG. 17 is a schematic block diagram illustrating a case in which a first air conditioning device and a second air conditioning device of a cabin cooling/heating system for a vehicle according to another embodiment of the present disclosure are used to cool or heat a cabin, and a floor heat exchanger is used to cool or heat a cabin floor.

FIG. 18 is a schematic configuration view illustrating a case in which a first air conditioning device and a second air conditioning device of a cabin cooling/heating system for a vehicle according to another embodiment of the present disclosure are used to cool a cabin, and a floor heat exchanger is used to cool a cabin floor.

FIG. 19 is a schematic configuration view illustrating a case in which a first air conditioning device and a second air conditioning device of a cabin cooling/heating system for a vehicle according to another embodiment of the present disclosure are used to heat a cabin, and a floor heat exchanger is used to heat a cabin floor.

FIG. 20 is a schematic block diagram of a cabin cooling/heating system for a vehicle according to still another embodiment of the present disclosure.

FIG. 21 is a schematic block diagram illustrating a case in which an air conditioning device of a cabin cooling/heating system for a vehicle according to still another embodiment of the present disclosure is used to cool or heat a cabin.

FIG. 22 is a schematic block diagram illustrating a case in which an air conditioning device of a cabin cooling/heating system for a vehicle according to still another embodiment of the present disclosure is used to cool a cabin.

FIG. 23 is a schematic block diagram illustrating a case in which a first air conditioning device of a cabin cooling/heating system for a vehicle according to still another embodiment of the present disclosure is used to heat a cabin.

FIG. 24 is a schematic block diagram illustrating a case in which a first air conditioning device and a second air conditioning device of a cabin cooling/heating system for a vehicle according to still another embodiment of the present disclosure are used to cool or heat a cabin.

FIG. 25 is a schematic block diagram illustrating a case in which a first air conditioning device and a second air conditioning device of a cabin cooling/heating system for a vehicle according to still another embodiment of the present disclosure are used to cool a cabin.

FIG. 26 is a schematic block diagram illustrating a case in which a first air conditioning device and a second air conditioning device of a cabin cooling/heating system for a vehicle according to still another embodiment of the present disclosure are used to heat a cabin.

FIG. 27 is a schematic block diagram illustrating a case in which a first air conditioning device and a second air conditioning device of a cabin cooling/heating system for a vehicle according to still another embodiment of the present disclosure are used to cool or heat a cabin, and a floor heat exchanger is used to cool or heat a cabin floor.

FIG. 28 is a schematic block diagram illustrating a case in which a first air conditioning device and a second air conditioning device of a cabin cooling/heating system for a vehicle according to still another embodiment of the present disclosure are used to cool a cabin, and a floor heat exchanger is used to cool a cabin floor.

FIG. 29 is a schematic block diagram illustrating a case in which a first air conditioning device and a second air conditioning device of a cabin cooling/heating system for a vehicle according to still another embodiment of the present disclosure are used to heat a cabin, and a floor heat exchanger is used to heat a cabin floor.

It should be understood that the accompanying drawings are not necessarily drawn to scale, but provide a somewhat simplified representation of various preferred features that demonstrate the basic principles of the present disclosure. For example, specific design features of the present disclosure, including particular dimensions, directions, positions, and shapes, should be partially determined by the particularly intended application and use environment.

### DETAILED DESCRIPTION

The terms used herein are merely for the purpose of describing a specific embodiment, and are not intended to limit the present disclosure. The singular expressions used herein are intended to include the plural expressions unless the context clearly dictates otherwise. It should be understood that the terms “comprise (include)” and/or “comprising (including)” used in the present specification mean that the features, the integers, the steps, the operations, the constituent elements, and/or component are present, but the presence or addition of one or more of other features, integers, steps, operations, constituent elements, components, and/or groups thereof is not excluded. The term “and/or” used herein includes any one or all of the combinations of listed related items.

As used in the present specification, the terms “mobility” or “of mobility” or similar terms include: general land mobility, passenger vehicles, sport utility vehicles (SUVs), buses, trucks, various commercial vehicles, and the like. Such terms may also include: marine mobility, including various boats and ships; and aerial mobility, including aircraft, drones, and the like. Additionally, such terms may include any object capable of moving by receiving power from a power source. Further, as used in the present specification, the terms “mobility” or “of mobility” or similar terms are to be understood as including hybrid mobility, electric mobility, plug-in hybrid mobility, hydrogen-powered mobility, and mobility using alternative fuel (e.g., fuel derived from sources other than petroleum). As referenced in the present specification, hybrid mobility includes mobility having two or more power sources, such as gasoline-powered mobility and electric-powered mobility. The mobility according to the embodiment of the present disclosure includes not only mobility that is operated manually, but also mobility that is somewhat autonomously and/or automatically operated.

In addition, should be understood that one or more of the following methods or aspects thereof may be carried out by at least one controller. The term “controller” may refer to a hardware device including a memory and a processor. The memory is configured to store program instructions, and the processor is specially programmed to execute the program instructions to perform one or more processes described below in more detail. The controller may control operations of units, modules, components, devices, or the like, as described herein. In addition, should be understood that the following methods may be carried out by an apparatus including the controller as well as one or more other components, as recognized by those having ordinary skill in the art.

In addition, the controller of the present disclosure may be implemented as a non-transitory computer-readable recording medium containing executable program instructions executed by a processor. Examples of the computer-readable recording media include, but are not limited to, read-only memory (ROM) s, random access memory (RAM) s, compact disc (CD)-ROMs, magnetic tapes, floppy disks, flash drives, smart cards, and optical data storage devices. The computer-readable recording medium can also be distributed in an overall computer network so that the program instruction may be stored and executed in a distributed manner, e.g., by a telematics server or a controller area network (CAN).

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, embodiments of the present disclosure are described in detail with reference to the accompanying drawings.

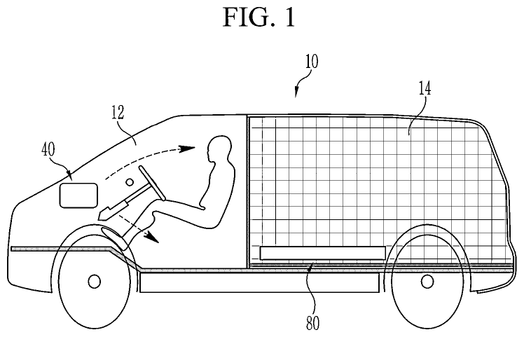

FIG. 1 is a schematic view of a vehicle equipped with a cabin cooling/heating system for a vehicle according to an embodiment of the present disclosure.

As illustrated in FIG. 1, a vehicle 10 equipped with a cabin cooling/heating system for a vehicle according to an embodiment of the present disclosure includes a cabin in which occupants may be positioned. The cabin includes a front cabin 12 and a rear cabin 14. The front cabin 12 is provided at a front portion of the vehicle, and a driver seat and a passenger seat are positioned in the front cabin 12. The rear cabin 14 is provided at a rear portion of the vehicle, and rear seats are positioned in the rear cabin 14. The front cabin 12 and the rear cabin 14 may be separated by various means. As an example, the front cabin 12 and the rear cabin 14 may be separated by the backrests of the front seats.

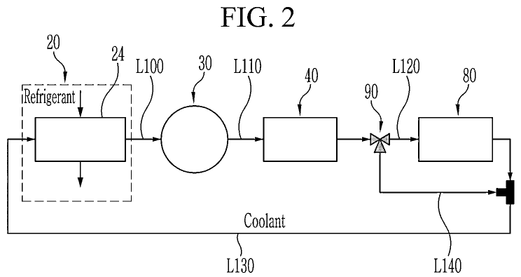

FIG. 2 is a schematic block diagram of the cabin cooling/heating system for a vehicle according to the embodiment of the present disclosure.

As illustrated in FIG. 2, the cabin cooling/heating system for a vehicle according to the embodiment of the present disclosure includes a heat pump system 20, a water pump module 30, and an air conditioning device 40.

The heat pump system 20 is configured to provide cold or hot water by using a refrigerant circulating in a heat pump and to supply the cold or hot water. The heat pump system 20 includes a heat pump heat exchanger 24. The heat pump heat exchanger 24 provides the cold or hot water by exchanging heat between a water and the refrigerant. The heat pump heat exchanger 24 may include a heat exchanger positioned at one position, and a heat exchanger positioned at another position.

The water pump module 30 is fluidly connected to the heat pump system 20 through a first suction line module L100 and configured to pump the cold or hot water from the heat pump system 20. The water pump module 30 is connected to the air conditioning device 40 through a first supply line module L110 and configured to allow the pumped cold or hot water to pass through the air conditioning device 40.

The air conditioning device 40 is fluidly connected to the water pump module 30 through the first supply line module L110 and receives the cold or hot water pumped by the water pump module 30. The air conditioning device 40 provides cold air or warm air by exchanging heat between the cold water and air or between the hot water and the air. As illustrated in FIG. 1, the air conditioning device 40 is mounted in the front cabin 12 and configured to cool or heat the cabin by blowing the cold or warm air into the cabin. The air conditioning device 40 is connected to the heat pump system 20 through a return line module L130, such that the cold or hot water returns to the heat pump system 20 through the return line module L130.

The cabin cooling/heating system for a vehicle further includes a floor heat exchanger 80 and a line switching valve module 90.

The floor heat exchanger 80 is fluidly connected to the air conditioning device 40 through a second supply line module L120 and configured to receive the cold or hot water from the air conditioning device 40. As illustrated in FIG. 1, the floor heat exchanger 80 is mounted in a cabin floor of the rear cabin 14 and configured to cool or heat the cabin floor of the rear cabin 14 by circulating the cold or hot water, which is supplied from the air conditioning device 40, through the cabin floor. For example, the floor heat exchanger 80 may be a water pipe uniformly embedded in the cabin floor of the rear cabin 14. In this case, the example is described in which the floor heat exchanger 80 is mounted in the cabin floor of the rear cabin 14. However, the position of the floor heat exchanger 80 is not limited thereto. The floor heat exchanger 80 may be mounted in at least one of the cabin floor of the front cabin 12 and the cabin floor of the rear cabin 14 and may be configured to cool or heat the cabin floor. The floor heat exchanger 80 is connected to the return line module L130, such that the cold or hot water, which has circulated through the floor heat exchanger 80, returns to the heat pump system 20 through the return line module L130.

The line switching valve module 90 is mounted in the second supply line module L120 that connects the air conditioning device 40 and the floor heat exchanger 80. The line switching valve module 90 is configured to send the cold or hot water from the air conditioning device 40 to the floor heat exchanger 80 or a flow switching line module L140. In other words, the line switching valve module 90 selectively and fluidly connects the air conditioning device 40 to the floor heat exchanger 80 or the flow switching line module L140. The flow switching line module L140 is fluidly connected to the return line module L130 while bypassing the floor heat exchanger 80. Therefore, the cold or hot water in the air conditioning device 40 may flow to the return line module L130 while passing through the floor heat exchanger 80 or flow to the return line module L130 through the flow switching line module L140 without passing through the floor heat exchanger 80, depending on a switching operation of the line switching valve module 90.

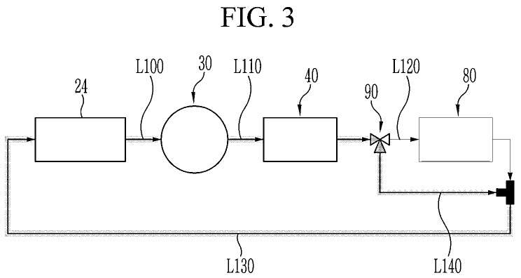

Hereinafter, a case in which the air conditioning device of the cabin cooling/heating system for a vehicle according to the embodiment of the present disclosure is used to cool or heat the cabin is described with reference to FIG. 3.

FIG. 3 is a schematic block diagram illustrating a case in which the air conditioning device of the cabin cooling/heating system for a vehicle according to the embodiment of the present disclosure is used to cool or heat the cabin.

As illustrated in FIG. 3, in order to cool or heat the cabin by using the air conditioning device 40 of the cabin cooling/heating system for a vehicle, the heat pump heat exchanger 24 provides the cold or hot water by exchanging heat the refrigerant. The water pump module 30 sends the cold or hot water to the air conditioning device 40 through the first supply line module L110 by pumping the cold or hot water through the first suction line module L100. The air conditioning device 40 provides the cold or warm air by exchanging heat between the cold water and the air or between the hot water and the air and cools or heats the cabin by blowing the cold or warm air into the cabin. In addition, the cold or hot water, which has exchanged heat with the air, flows to the second supply line module L120, and the line switching valve module 90 connects the second supply line module L120 to the flow switching line module L140, such that the cold or hot water returns back to the heat pump heat exchanger 24 through the flow switching line module L140 and the return line module L130.

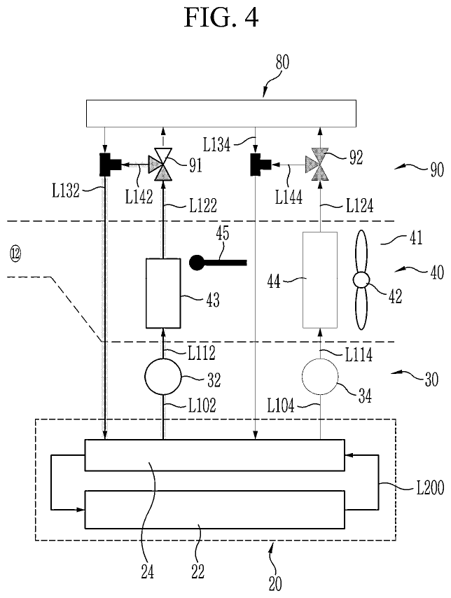

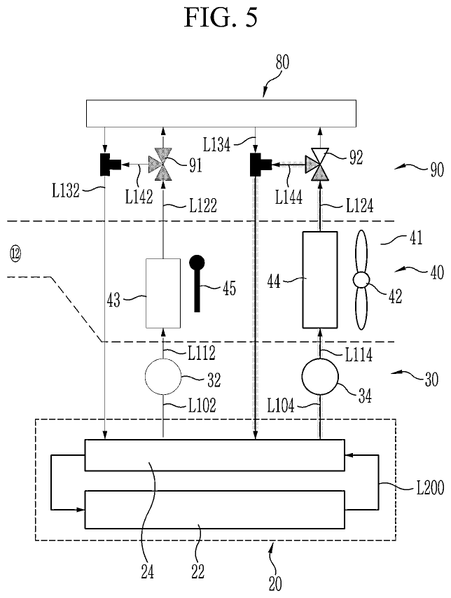

Hereinafter, the case in which the air conditioning device of the cabin cooling/heating system for a vehicle according to the embodiment of the present disclosure is used to cool or heat the cabin is described in more detail with reference to FIGS. 4 and 5.

FIG. 4 is a configuration view illustrating a case in which the air conditioning device of the cabin cooling/heating system for a vehicle according to the embodiment of the present disclosure is used to heat the cabin. FIG. 5 is a configuration view illustrating a case in which the air conditioning device of the cabin cooling/heating system for a vehicle according to the embodiment of the present disclosure is used to cool the cabin.

As illustrated in FIGS. 4 and 5, the heat pump system 20 further includes a heat pump 22. The heat pump 22 may provide the hot water by supplying thermal energy to the water in the heat pump heat exchanger 24 by using the refrigerant circulating through a refrigerant circulation line L200. Alternatively, the heat pump 22 may provide the cold water by recovering thermal energy from the water in the heat pump heat exchanger 24. In general, the heat pump 22 includes a compressor and an expansion valve. The compressor compresses the refrigerant to raise a temperature of the refrigerant and sends the refrigerant with the raised temperature to the heat pump heat exchanger 24 to provide the hot water from the water. The expansion valve expands the refrigerant to lower the temperature of the refrigerant and sends the refrigerant with the lowered temperature to the heat pump heat exchanger 24 to provide the cold water from the water. Because the heat pump system 20 is well known to those having ordinary skill in the art, a further detailed description thereof has been omitted.

The first suction line module L100 includes a first hot water suction line L102 and a first cold water suction line L104. The first hot water suction line L102 is connected to a hot water generation portion of the heat pump heat exchanger 24, and the hot water provided by the hot water generation portion of the heat pump heat exchanger 24 flows to the first hot water suction line L102. The first cold water suction line L104 is connected to a cold water generation portion of the heat pump heat exchanger 24, and the cold water provided by the cold water generation portion of the heat pump heat exchanger 24 flows to the first cold water suction line L104.

The water pump module 30 includes first and second water pumps 32 and 34. The first water pump 32 is connected to the first hot water suction line L102 and pumps the hot water provided by the hot water generation portion of the heat pump heat exchanger 24. The second water pump 34 is connected to the first cold water suction line L104 and pumps the cold water provided by the cold water generation portion of the heat pump heat exchanger 24.

The first supply line module L110 includes a first hot water supply line L112 and a first cold water supply line L114. The first hot water supply line L112 is connected to the first water pump 32, such that the hot water pumped by the first water pump 32 flows to the first hot water supply line L112. The first cold water supply line L114 is connected to the second water pump 34, such that the cold water pumped by the second water pump 34 flows to the first cold water supply line L114.

The air conditioning device 40 includes an air passageway 41, a heater core 43, and a cooler 44 disposed in the air passageway 41.

The air passageway 41 allows an inside air or an outside air of the vehicle 10 to communicate with the front cabin 12 so that outside air disposed outside the vehicle 10 flows into the front cabin 12. An air blower 42 is disposed in the air passageway 41 and blows inside or outside air of the vehicle 10 into the air passageway 41. The drawings illustrate that the air blower 42 is disposed at an upstream side of the cooler 44. However, the air blower 42 may be disposed at any position at which the air blower 42 may send the inside or outside air of the vehicle to the front cabin 12 through the air passageway 41.

The heater core 43 is disposed in the air passageway 41, provides the warm air by heating the inside or outside air of the vehicle passing through the heater core 43, and supplies the warm air into the cabin, particularly the front cabin 12 to heat the cabin. The heater core 43 is connected to the first hot water supply line L112, receives the hot water pumped by the first water pump 32, and heats the inside or outside air of the vehicle, which passes through the heater core 43, by using the hot water. An air door 45 is mounted in the air passageway 41 through which the inside or outside air of the vehicle flows toward the heater core 43 from the outside of the vehicle 10. The air door 45 selectively opens or closes the air passageway 41 through which the inside or outside air of the vehicle flows toward the heater core 43. In other words, the air door 45 may close the air passageway 41, through which the inside or outside air of the vehicle flows toward the heater core 43, to prevent the inside or outside air of the vehicle from passing through the heater core 43. Alternatively, the air door 45 may open the air passageway 41, through which the inside or outside air of the vehicle flows toward the heater core 43, to allow the inside or outside air of the vehicle to pass through the heater core 43. Therefore, the inside or outside air of the vehicle is heated by the heater core 43 when the air door 45 opens the air passageway 41. The inside or outside air of the vehicle is not heated by the heater core 43 when the air door 45 closes the air passageway 41.

The cooler 44 is disposed in the air passageway 41, provides the cold air by cooling the inside or outside air of the vehicle passing through the cooler 44, and supplies the cold air into the cabin, particularly the front cabin 12 to cool the cabin. The cooler 44 is connected to the first cold water supply line L114, receives the cold water pumped by the second water pump 34, and cools the inside or outside air of the vehicle, which passes through the cooler 44, by using the cold water.

The second supply line module L120 includes a second hot water supply line L122 and a second cold water supply line L124. The second hot water supply line L122 is fluidly connected to the heater core 43, such that the hot water, which has exchanged heat with the inside or outside air of the vehicle while passing through the heater core 43, flows to the second hot water supply line L122. The second cold water supply line L124 is fluidly connected to the cooler 44, such that the cold water, which has exchanged heat with the inside or outside air of the vehicle while passing through the cooler 44, flows to the second cold water supply line L124.

The line switching valve module 90 includes a first line switching valve 91 and a second line switching valve 92. The first line switching valve 91 is fluidly connected to the second hot water supply line L122, such that the hot water flowing along the second hot water supply line L122 flows to the first line switching valve 91. The first line switching valve 91 is selectively connected to the floor heat exchanger 80 or a hot water flow switching line L142 of the flow switching line module L140, such that the hot water selectively flows to the floor heat exchanger 80 or the hot water flow switching line L142. The second line switching valve 92 is fluidly connected to the second cold water supply line L124, such that the cold water flowing along the second cold water supply line L124 flows to the second line switching valve 92. The second line switching valve 92 is selectively connected to the floor heat exchanger 80 or a cold water flow switching line L144 of the flow switching line module L140, such that the cold water selectively flows to the floor heat exchanger 80 or the cold water flow switching line L144.

The return line module L130 includes a hot water return line L132 and a cold water return line L134. The hot water return line L132 is fluidly connected to the floor heat exchanger 80 and the hot water flow switching line L142. Therefore, the hot water having circulated through the floor heat exchanger 80 or the hot water having flowed to the hot water flow switching line L142 by the first line switching valve 91 returns to the heat pump system 20 through the hot water return line L132. The cold water return line L134 is fluidly connected to the floor heat exchanger 80 and the cold water flow switching line L144. Therefore, the cold water having circulated through the floor heat exchanger 80 or the cold water having flowed to the cold water flow switching line L144 by the second line switching valve 92 returns to the heat pump system 20 through the cold water return line L134.

As illustrated in FIG. 4, in order to heat the cabin by using the air conditioning device 40 of the cabin cooling/heating system for a vehicle, the heat pump system 20 provides hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the first line switching valve 91, and the first line switching valve 91 sends the hot water to the hot water flow switching line L142. In this case, the first line switching valve 91 closes the second hot water supply line L122 directed toward the floor heat exchanger 80, such that the hot water is not supplied to the floor heat exchanger 80. Therefore, the cabin floor is not heated, and the hot water returns to the heat pump system 20 through the hot water return line L132.

As illustrated in FIG. 5, in order to cool the cabin by using the air conditioning device 40 of the cabin cooling/heating system for a vehicle, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. The hot water is not supplied to the heater core 43, and the air door 45 closes the air passageway 41 directed toward the heater core 43, such that the inside or outside air of the vehicle is not heated by the heater core 43.

The cold water, which has passed through the cooler 44, flows to the second line switching valve 92, and the second line switching valve 92 sends the cold water to the cold water flow switching line L144. In this case, the second line switching valve 92 closes the second cold water supply line L124 directed toward the floor heat exchanger 80, such that the cold water is not supplied to the floor heat exchanger 80. Therefore, the cabin floor is not cooled, and the cold water returns to the heat pump system 20 through the cold water return line L134.

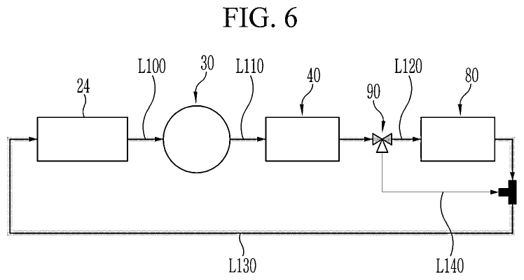

Hereinafter, a case in which the air conditioning device of the cabin cooling/heating system for a vehicle according to the embodiment of the present disclosure is used to cool or heat the cabin and the floor heat exchanger is used to cool or heat the cabin floor is described with reference to FIG. 6.

FIG. 6 is a schematic block diagram illustrating the case in which the air conditioning device of the cabin cooling/heating system for a vehicle according to the embodiment of the present disclosure is used to cool or heat the cabin, and the floor heat exchanger is used to cool or heat the cabin floor.

As illustrated in FIG. 6, in order to cool or heat the cabin by using the air conditioning device 40 of the cabin cooling/heating system for a vehicle and to cool or heat the cabin floor by using the floor heat exchanger 80, the heat pump heat exchanger 24 provides the cold or hot water by exchanging heat with the refrigerant. The water pump module 30 sends the cold or hot water to the air conditioning device 40 through the first supply line module L110 by pumping the cold or hot water through the first suction line module L100. The air conditioning device 40 provides the cold air or warm air by exchanging heat between the cold water and the air or between the hot water and the air and cools or heats the cabin by blowing the cold air or warm air into the cabin. In addition, the cold or hot water, which has exchanged heat with the air, flows to the second supply line module L120, and the line switching valve module 90 connects the second supply line module L120 to the floor heat exchanger 80, such that the cold or hot water flows to the floor heat exchanger 80 through the second supply line module L120. The cold or hot water, which has flowed to the floor heat exchanger 80, cools or heats the cabin floor while circulating through the floor heat exchanger 80. The cold or hot water, which has circulated through the floor heat exchanger 80, returns back to the heat pump heat exchanger 24 through the return line module L130.

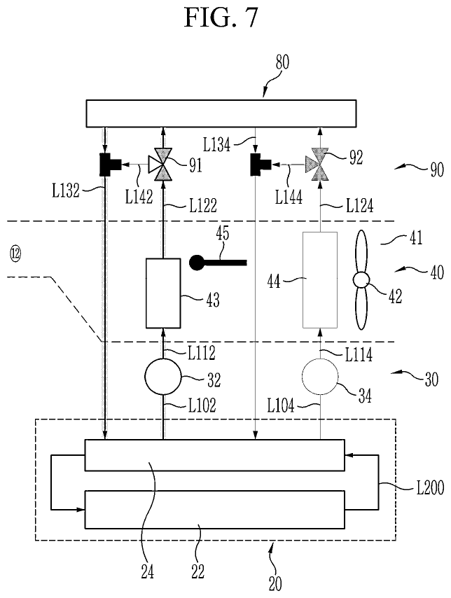

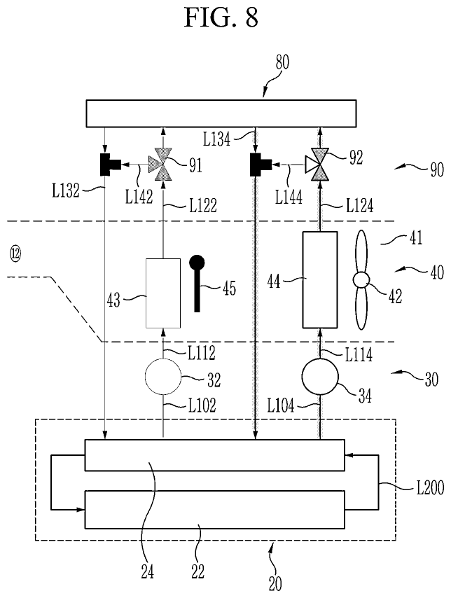

Hereinafter, the case in which the air conditioning device of the cabin cooling/heating system for a vehicle according to the embodiment of the present disclosure is used to cool or heat the cabin and the floor heat exchanger is used to cool or heat the cabin floor is described in more detail with reference to FIGS. 7 and 8.

FIG. 7 is a configuration view illustrating a case in which the air conditioning device of the cabin cooling/heating system for a vehicle according to the embodiment of the present disclosure is used to heat the cabin, and the floor heat exchanger is used to heat the cabin floor. FIG. 8 is a configuration view illustrating a case in which the air conditioning device of the cabin cooling/heating system for a vehicle according to the embodiment of the present disclosure is used to cool the cabin, and the floor heat exchanger is used to cool the cabin floor.

As illustrated in FIG. 7, in order to heat the cabin by using the air conditioning device 40 of the cabin cooling/heating system for a vehicle and heat the cabin floor by using the floor heat exchanger 80, the heat pump system 20 provides hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the first line switching valve 91, and the first line switching valve 91 sends the hot water to the floor heat exchanger 80. The hot water heats the cabin floor while circulating through the floor heat exchanger 80 and returns to the heat pump system 20 through the hot water return line L132.

As illustrated in FIG. 8, in order to cool the cabin by using the air conditioning device 40 of the cabin cooling/heating system for a vehicle and cool the cabin floor by using the floor heat exchanger 80, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. The hot water is not supplied to the heater core 43, and the air door 45 closes the air passageway 41 directed toward the heater core 43, such that the inside or outside air of the vehicle is not heated by the heater core 43.

The cold water, which has passed through the cooler 44, flows to the second line switching valve 92, and the second line switching valve 92 sends the cold water to the floor heat exchanger 80. The cold water cools the cabin floor while circulating through the floor heat exchanger 80 and returns to the heat pump system 20 through the cold water return line L134.

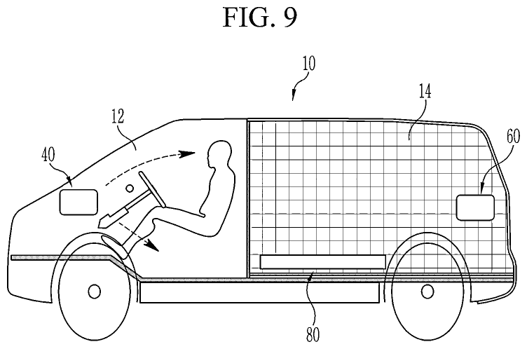

FIG. 9 is a schematic view of a vehicle equipped with a cabin cooling/heating system for a vehicle according to another embodiment of the present disclosure.

As illustrated in FIG. 9, the vehicle 10 equipped with the cabin cooling/heating system for a vehicle according to another embodiment of the present disclosure includes the cabin in which occupants may be positioned. The cabin includes the front cabin 12 and the rear cabin 14.

The air conditioning device 40 is mounted in the front cabin 12, and the air conditioning device 40 cools or heats the cabin by blowing the cold air or the warm air into the front cabin 12. The floor heat exchanger 80 is mounted in the cabin floor of the rear cabin 14, and the floor heat exchanger 80 cools or heats the cabin floor by using the cold or hot water that circulates through the floor heat exchanger 80. In addition, a second air conditioning device 60 is mounted in the rear cabin 14, and the second air conditioning device 60 cools or heats the cabin by blowing the cold air or the warm air into the rear cabin 14.

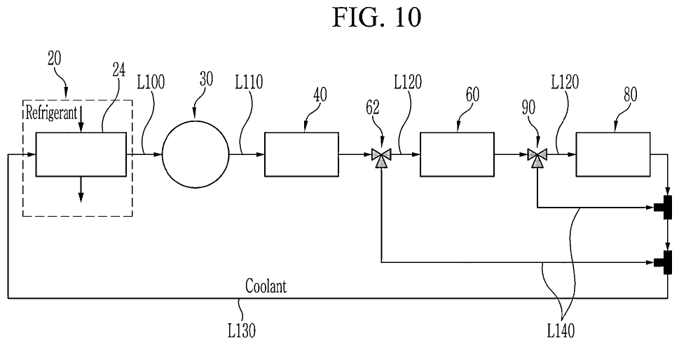

FIG. 10 is a schematic block diagram of the cabin cooling/heating system for a vehicle according to another embodiment of the present disclosure.

As illustrated in FIG. 10, the cabin cooling/heating system for a vehicle according to another embodiment of the present disclosure includes the heat pump system 20, the water pump module 30, the air conditioning device 40, the second air conditioning device 60, and the floor heat exchanger 80.

The heat pump system 20 includes the heat pump heat exchanger 24. The heat pump heat exchanger 24 provides the cold or hot water by exchanging heat between the water and the refrigerant.

The water pump module 30 is fluidly connected to the heat pump system 20 through the first suction line module L100 and configured to pump the cold or hot water from the heat pump system 20. The water pump module 30 is connected to the air conditioning device 40 through the first supply line module L110 and configured to allow the pumped cold or hot water to pass through the air conditioning device 40.

The air conditioning device 40 is fluidly connected to the water pump module 30 through the first supply line module L110 and receives the cold or hot water pumped by the water pump module 30. The air conditioning device 40 provides the cold air or the warm air by exchanging heat between the cold water and the air or between the hot water and the air. As illustrated in FIG. 9, the air conditioning device 40 is mounted in the front cabin 12 and configured to cool or heat the cabin by blowing the cold air or warm air into the front cabin 12.

The second air conditioning device 60 is fluidly connected to the air conditioning device 40 through the second supply line module L120 and receives the cold or hot water from the air conditioning device 40. The second air conditioning device 60 also provides the cold air or the warm air by exchanging heat between the cold water and the air or between the hot water and the air. As illustrated in FIG. 9, the second air conditioning device 60 is mounted in the rear cabin 14 and configured to cool or heat the cabin by blowing the cold air or warm air into the rear cabin 14. FIG. 10 illustrates that the cold or hot water, which has passed through the air conditioning device 40, flows to the return line module L130 while bypassing the second air conditioning device 60. However, it should be understood that this configuration is merely provided for the convenience of description. The cold or hot water, which has passed through the air conditioning device 40, always flows to the second air conditioning device 60. However, it should be understood that the drawing illustrates that the cold or hot water is supplied to the second air conditioning device 60 when the inside or outside air of the vehicle passes through the second air conditioning device 60, and the cold or hot water bypasses the second air conditioning device 60 when the inside or outside air of the vehicle does not pass through the second air conditioning device 60.

The floor heat exchanger 80 is fluidly connected to the second air conditioning device 60 through the second supply line module L120 and configured to receive the cold or hot water from the second air conditioning device 60. As illustrated in FIG. 9, the floor heat exchanger 80 is mounted in the cabin floor of the rear cabin 14 and configured to cool or heat the cabin floor of the rear cabin 14 by circulating the cold or hot water supplied from the second air conditioning device 60. The floor heat exchanger 80 is connected to the return line module L130, such that the cold or hot water, which has circulated through the floor heat exchanger 80, returns to the heat pump system 20 through the return line module L130.

The cabin cooling/heating system for a vehicle further includes the line switching valve module 90.

The line switching valve module 90 is mounted in the second supply line module L120 that connects the second air conditioning device 60 and the floor heat exchanger 80. The line switching valve module 90 is configured to send the cold or hot water from the second air conditioning device 60 to the floor heat exchanger 80 or the flow switching line module L140. In other words, the line switching valve module 90 selectively and fluidly connects the second air conditioning device 60 to the floor heat exchanger 80 or the flow switching line module L140. The flow switching line module L140 is fluidly connected to the return line module L130 while bypassing the floor heat exchanger 80. Therefore, the cold or hot water in the second air conditioning device 60 may flow to the return line module L130 while passing through the floor heat exchanger 80 or flow to the return line module L130 through the flow switching line module L140 without passing through the floor heat exchanger 80, depending on the switching operation of the line switching valve module 90.

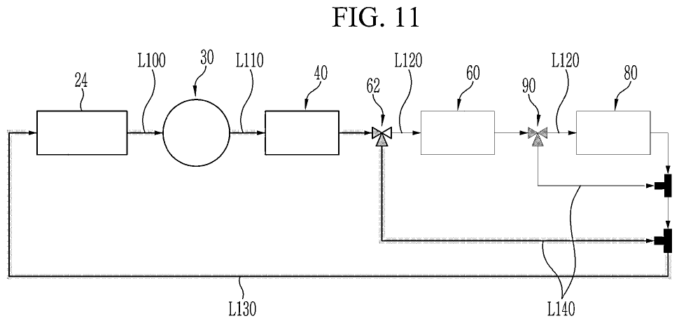

Hereinafter, a case in which the air conditioning device of the cabin cooling/heating system for a vehicle according to another embodiment of the present disclosure is used to cool or heat the cabin is described with reference to FIG. 11.

FIG. 11 is a schematic block diagram illustrating the case in which the air conditioning device of the cabin cooling/heating system for a vehicle according to another embodiment of the present disclosure is used to cool or heat the cabin.

As illustrated in FIG. 11, in order to cool or heat the cabin by using the air conditioning device 40 of the cabin cooling/heating system for a vehicle, the heat pump heat exchanger 24 provides the cold or hot water by exchanging heat with the refrigerant. The water pump module 30 sends the cold or hot water to the air conditioning device 40 through the first supply line module L110 by pumping the cold or hot water through the first suction line module L100. The air conditioning device 40 provides the cold air or the warm air by exchanging heat between the cold water and the air or between the hot water and the air, and cools or heats the cabin by blowing the cold air or the warm air into the front cabin 12. In addition, the cold or hot water, which has exchanged heat with the air, flows to the second air conditioning device 60 through the second supply line module L120. However, because the inside or outside air of the vehicle is not blown to the second air conditioning device 60, the rear cabin 12 is not cooled or heated by the second air conditioning device 60. The cold or hot water, which has flowed to the second air conditioning device 60, flows to the flow switching line module L140 by the line switching valve module 90 and returns back to the heat pump heat exchanger 24 through the return line module L130.

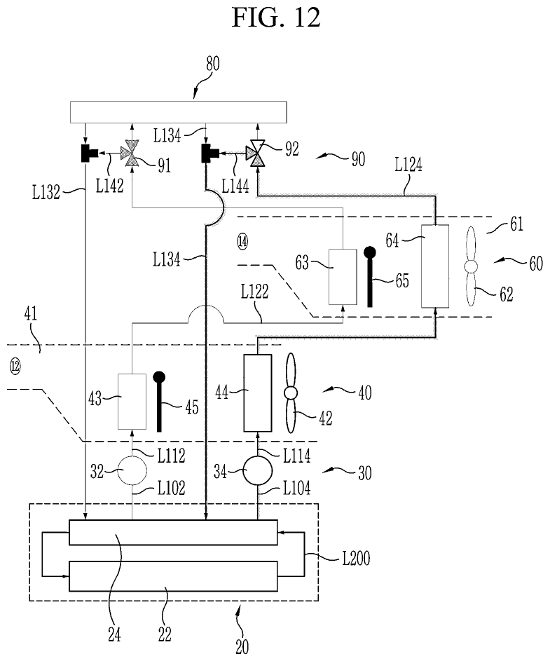

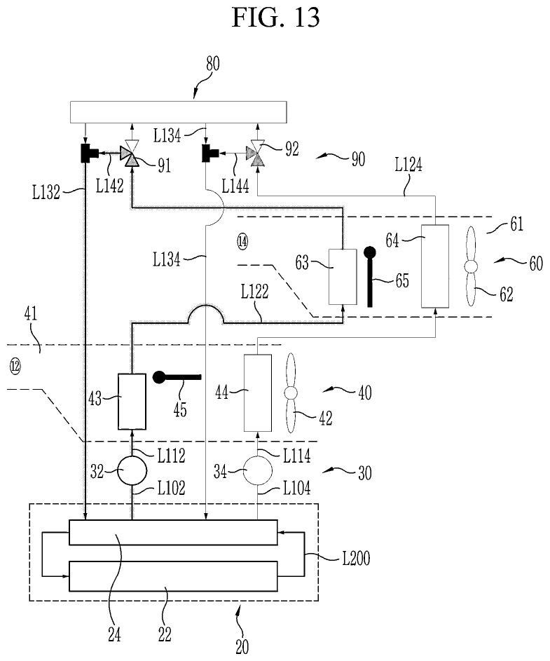

Hereinafter, the case in which the air conditioning device of the cabin cooling/heating system for a vehicle according to another embodiment of the present disclosure is used to cool or heat the cabin is described in more detail with reference to FIGS. 12 and 13.

FIG. 12 is a configuration view illustrating a case in which the air conditioning device of the cabin cooling/heating system for a vehicle according to another embodiment of the present disclosure is used to cool the cabin. FIG. 13 is a configuration view illustrating a case in which the air conditioning device of the cabin cooling/heating system for a vehicle according to another embodiment of the present disclosure is used to heat the cabin.

As illustrated in FIGS. 12 and 13, the heat pump system 20 further includes the heat pump 22. The heat pump 22 may provide the hot water by supplying thermal energy to the water in the heat pump heat exchanger 24 by using the refrigerant circulating through the refrigerant circulation line L200 or provide the cold water by recovering thermal energy from the water in the heat pump heat exchanger 24.

The first suction line module L100 includes the first hot water suction line L102 and the first cold water suction line L104. The first hot water suction line L102 is connected to the hot water generation portion of the heat pump heat exchanger 24. The hot water provided by the hot water generation portion of the heat pump heat exchanger 24 flows to the first hot water suction line L102. The first cold water suction line L104 is connected to the cold water generation portion of the heat pump heat exchanger 24. The cold water provided by the cold water generation portion of the heat pump heat exchanger 24 flows to the first cold water suction line L104.

The water pump module 30 includes the first and second water pumps 32 and 34. The first water pump 32 is connected to the first hot water suction line L102 and pumps the hot water provided by the hot water generation portion of the heat pump heat exchanger 24. The second water pump 34 is connected to the first cold water suction line L104 and pumps the cold water provided by the cold water generation portion of the heat pump heat exchanger 24.

The first supply line module L110 includes the first hot water supply line L112 and the first cold water supply line L114. The first hot water supply line L112 is connected to the first water pump 32, such that the hot water pumped by the first water pump 32 flows to the first hot water supply line L112. The first cold water supply line L114 is connected to the second water pump 34, such that the cold water pumped by the second water pump 34 flows to the first cold water supply line L114.

The air conditioning device 40 includes the air passageway 41, the heater core 43, and the cooler 44 disposed in the air passageway 41.

The air passageway 41 allows the inside or outside of the vehicle 10 to communicate with the front cabin 12 so that the air outside the vehicle 10 flows into the front cabin 12. The air blower 42 is disposed in the air passageway 41 and blows the inside or outside air of the vehicle into the air passageway 41. The drawings illustrate that the air blower 42 is disposed at the upstream side of the cooler 44. However, the air blower 42 may be disposed at any position at which the air blower 42 may send the inside or outside air of the vehicle to the front cabin 12 through the air passageway 41.

The heater core 43 is disposed in the air passageway 41 and configured to provide the warm air by heating the inside or outside air of the vehicle passing through the heater core 43 and supplying the warm air into the cabin, particularly into the front cabin 12 to heat the cabin. The heater core 43 is connected to the first hot water supply line L112, receives the hot water pumped by the first water pump 32, and heats the inside or outside air of the vehicle, which passes through the heater core 43, by using the hot water. The air door 45 is mounted in the air passageway 41 through which the inside or outside air of the vehicle flows toward the heater core 43 from the outside of the vehicle 10. The air door 45 selectively opens or closes the air passageway 41 through which the inside or outside air of the vehicle flows toward the heater core 43. In other words, the air door 45 may close the air passageway 41, through which the inside or outside air of the vehicle flows toward the heater core 43, to prevent the inside or outside air of the vehicle from passing through the heater core 43. Alternatively, the air door 45 may open the air passageway 41, through which the inside or outside air of the vehicle flows toward the heater core 43, to allow the inside or outside air of the vehicle to pass through the heater core 43. Therefore, the inside or outside air of the vehicle is heated by the heater core 43 when the air door 45 opens the air passageway 41. The inside or outside air of the vehicle is not heated by the heater core 43 when the air door 45 closes the air passageway 41.

The cooler 44 is disposed in the air passageway 41 and configured to provide the cold air by cooling the inside or outside air of the vehicle passing through the cooler 44 and supplying the cold air into the cabin, particularly into the front cabin 12 to cool the cabin. The cooler 44 is connected to the first cold water supply line L114, receives the cold water pumped by the second water pump 34, and cools the inside or outside air of the vehicle, which passes through the cooler 44, by using the cold water.

The second supply line module L120 includes the second hot water supply line L122 and the second cold water supply line L124. The second hot water supply line L122 is fluidly connected to the heater core 43, such that the hot water, which has exchanged heat with the inside or outside air of the vehicle while passing through the heater core 43, flows to the second hot water supply line L122. The second cold water supply line L124 is fluidly connected to the cooler 44, such that the cold water, which has exchanged heat with the inside or outside air of the vehicle while passing through the cooler 44, flows to the second cold water supply line L124.

The second air conditioning device 60 includes a second air passageway 61, a second heater core 63, and a second cooler 64 disposed in the second air passageway 61.

The second air passageway 61 allows the inside or outside of the vehicle 10 to communicate with the rear cabin 14 so that the air outside the vehicle 10 flows into the rear cabin 14. A second air blower 62 is disposed in the second air passageway 61 and blows the inside or outside air of the vehicle into the second air passageway 61.

The second heater core 63 is disposed in the second air passageway 61 and configured to provide the warm air by heating the inside or outside air of the vehicle passing through the second heater core 63 and supplying the warm air into the cabin, particularly into the rear cabin 14 to heat the cabin. The second heater core 63 is connected to the second hot water supply line L122, receives the hot water having passed through the heater core 43, and heats the inside or outside air of the vehicle, which passes through the second heater core 63, by using the hot water. A second air door 65 is mounted in the second air passageway 61 through which the inside or outside air of the vehicle flows toward the second heater core 63 from the outside of the vehicle 10. The second air door 65 selectively opens or closes the second air passageway 61 through which the inside or outside air of the vehicle flows toward the second heater core 63. In other words, the second air door 65 may close the second air passageway 61, through which the inside or outside air of the vehicle flows toward the second heater core 63, to prevent the inside or outside air of the vehicle from passing through the second heater core 63. Alternatively, the second air door 65 may open the second air passageway 61, through which the inside or outside air of the vehicle flows toward the second heater core 63, to allow the inside or outside air of the vehicle to pass through the second heater core 63. Therefore, the inside or outside air of the vehicle is heated by the second heater core 63 when the second air door 65 opens the second air passageway 61. The inside or outside air of the vehicle is not heated by the second heater core 63 when the second air door 65 closes the second air passageway 61.

The second cooler 64 is disposed in the second air passageway 61 and configured to provide the cold air by cooling the inside or outside air of the vehicle passing through the second cooler 64 and supplying the cold air into the cabin, particularly the rear cabin 14 to cool the cabin. The second cooler 64 is connected to the second cold water supply line L124, receives the cold water having passed through the second cooler 64, and cools the inside or outside air of the vehicle, which passes through the second cooler 64, by using the cold water.

The line switching valve module 90 includes the first line switching valve 91 and the second line switching valve 92. The first line switching valve 91 is fluidly connected to the second hot water supply line L122, such that the hot water, which has passed through the second heater core 63, flows to the first line switching valve 91. The first line switching valve 91 is selectively connected to the floor heat exchanger 80 or the hot water flow switching line L142 of the flow switching line module L140, such that the hot water selectively flows to the floor heat exchanger 80 or the hot water flow switching line L142. The second line switching valve 92 is fluidly connected to the second cold water supply line L124, such that the cold water, which has passed through the second cooler 64, flows to the second line switching valve 92. The second line switching valve 92 is selectively connected to the floor heat exchanger 80 or the cold water flow switching line L144 of the flow switching line module L140, such that the cold water selectively flows to the floor heat exchanger 80 or the cold water flow switching line L144.

The return line module L130 includes the hot water return line L132 and the cold water return line L134. The hot water return line L132 is fluidly connected to the floor heat exchanger 80 and the hot water flow switching line L142. Therefore, the hot water having circulated through the floor heat exchanger 80 or the hot water having flowed to the hot water flow switching line L142 by the first line switching valve 91 returns to the heat pump system 20 through the hot water return line L132. The cold water return line L134 is fluidly connected to the floor heat exchanger 80 and the cold water flow switching line L144. Therefore, the cold water having circulated through the floor heat exchanger 80 or the cold water having flowed to the cold water flow switching line L144 by the second line switching valve 92 returns to the heat pump system 20 through the cold water return line L134.

As illustrated in FIG. 12, in order to cool the cabin by using the air conditioning device 40 of the cabin cooling/heating system for a vehicle, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. The hot water is not supplied to the heater core 43, and the air door 45 closes the air passageway 41 directed toward the heater core 43, such that the inside or outside air of the vehicle is not heated by the heater core 43. Therefore, the cold air is blown to the front cabin 12 through the air conditioning device 40 to cool the cabin.

The cold water, which has passed through the cooler 44, flows to the second cooler 64. However, because the second air blower 62 does not operate, the cold air is not supplied to the rear cabin 14. The cold water, which has passed through the second cooler 64, flows to the second line switching valve 92, and the second line switching valve 92 sends the cold water to the cold water flow switching line L144. In this case, the second line switching valve 92 closes the second cold water supply line L124 directed toward the floor heat exchanger 80, such that the cold water is not supplied to the floor heat exchanger 80. Therefore, the cabin floor is not cooled, and the cold water returns to the heat pump system 20 through the cold water return line L134.

As illustrated in FIG. 13, in order to heat the cabin by using the air conditioning device 40 of the cabin cooling/heating system for a vehicle, the heat pump system 20 provides the hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the second heater core 63. However, because the second air blower 62 does not operate, the warm air is not supplied to the rear cabin 14. The hot water, which has passed through the second heater core 63, flows to the first line switching valve 91, and the first line switching valve 91 sends the hot water to the hot water flow switching line L142. In this case, the first line switching valve 91 closes the second hot water supply line L122 directed toward the floor heat exchanger 80, such that the hot water is not supplied to the floor heat exchanger 80. Therefore, the cabin floor is not heated, and the hot water returns to the heat pump system 20 through the hot water return line L132.

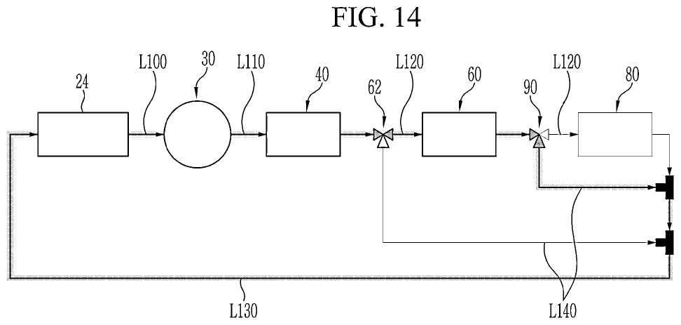

Hereinafter, a case in which the air conditioning device and the second air conditioning device of the cabin cooling/heating system for a vehicle according to another embodiment of the present disclosure are used to cool or heat the cabin is described with reference to FIG. 14.

FIG. 14 is a schematic block diagram illustrating the case in which the first air conditioning device and the second air conditioning device of the cabin cooling/heating system for a vehicle according to another embodiment of the present disclosure are used to cool or heat the cabin.

As illustrated in FIG. 14, in order to cool or heat the cabin by using the first air conditioning device 40 and the second air conditioning device 60 of the cabin cooling/heating system for a vehicle, the heat pump heat exchanger 24 provides the cold or hot water by exchanging heat with the refrigerant. The water pump module 30 sends the cold or hot water to the air conditioning device 40 through the first supply line module L110 by pumping the cold or hot water through the first suction line module L100. The air conditioning device 40 provides the cold air or the warm air by exchanging heat between the cold water and the air or between the hot water and the air and cools or heats the cabin by blowing the cold air or the warm air into the front cabin 12. In addition, the cold or hot water, which has exchanged heat with the air, flows to the second air conditioning device 60 through the second supply line module L120. The second air conditioning device 60 provides the cold air or the warm air by exchanging heat between the cold water and the air or between the hot water and the air and cools or heats the cabin by blowing the cold air or the warm air into the rear cabin 14. The cold or hot water, which has flowed to the second air conditioning device 60, flows to the flow switching line module L140 by the line switching valve module 90 and returns back to the heat pump heat exchanger 24 through the return line module L130.

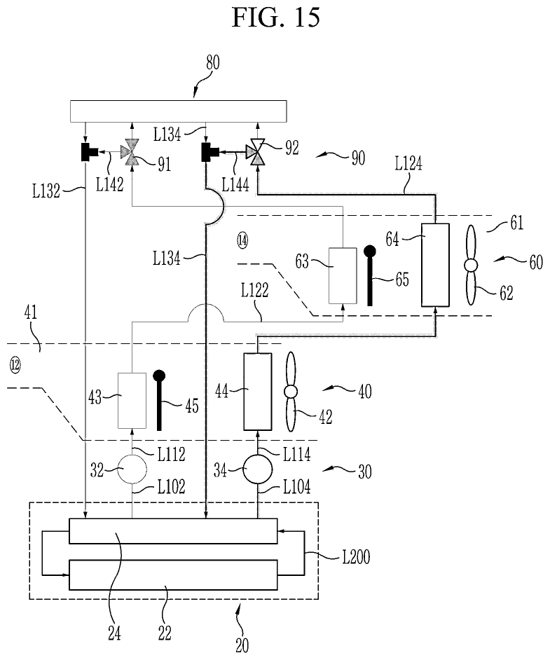

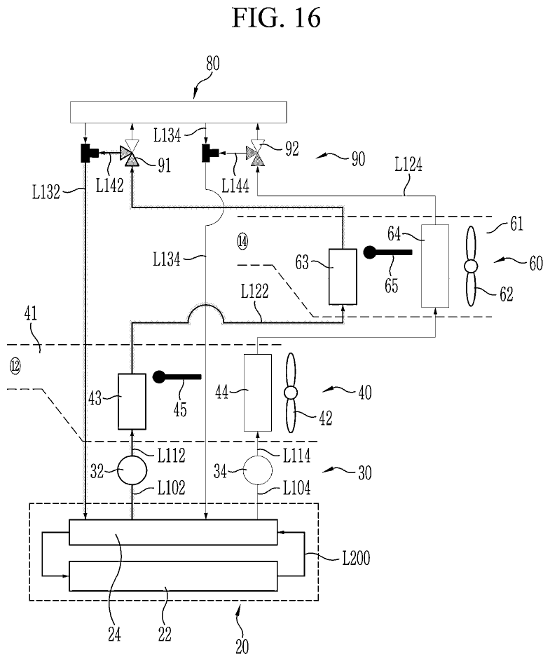

Hereinafter, the case in which the air conditioning device and the second air conditioning device of the cabin cooling/heating system for a vehicle according to another embodiment of the present disclosure are used to cool or heat the cabin is described in more detail with reference to FIGS. 15 and 16.

FIG. 15 is a configuration view illustrating a case in which the first air conditioning device and the second air conditioning device of the cabin cooling/heating system for a vehicle according to another embodiment of the present disclosure are used to cool the cabin. FIG. 16 is a configuration view illustrating a case in which the first air conditioning device and the second air conditioning device of the cabin cooling/heating system for a vehicle according to another embodiment of the present disclosure are used to heat the cabin.

As illustrated in FIG. 15, in order to cool the cabin by using the first air conditioning device 40 and the second air conditioning device 60 of the cabin cooling/heating system for a vehicle, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. Therefore, the cold air is blown to the front cabin 12 through the air conditioning device 40 to cool the cabin. The hot water is not supplied to the heater core 43, and the air door 45 closes the air passageway 41 directed toward the heater core 43, such that the inside or outside air of the vehicle is not heated by the heater core 43.

The cold water, which has passed through the cooler 44, flows to the second cooler 64, the second air blower 62 blows the inside or outside air of the vehicle to the second air passageway 61, and the inside or outside air of the vehicle is cooled to become the cold air by the cold water passing through the second cooler 64. The hot water is not supplied to the second heater core 63, and the second air door 65 closes the second air passageway 61, such that the inside or outside air of the vehicle is not heated by the second heater core 63. Therefore, the cold air is blown to the rear cabin 14 through the second air conditioning device 60 to cool the cabin.

The cold water, which has passed through the second cooler 64, flows to the second line switching valve 92, and the second line switching valve 92 sends the cold water to the cold water flow switching line L144. In this case, the second line switching valve 92 closes the second cold water supply line L124 directed toward the floor heat exchanger 80, such that the cold water is not supplied to the floor heat exchanger 80. Therefore, the cabin floor is not cooled, and the cold water returns to the heat pump system 20 through the cold water return line L134.

As illustrated in FIG. 16, in order to heat the cabin by using the air conditioning device 40 of the cabin cooling/heating system for a vehicle, the heat pump system 20 provides the hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the second heater core 63, the second air blower 62 blows the inside or outside air of the vehicle to the second air passageway 61, and the inside or outside air of the vehicle is heated to become the warm air by the hot water passing through the second heater core 63. The warm air is supplied to the rear cabin 14 to heat the cabin. In this case, because the cold water is not supplied to the second cooler 64, the inside or outside air of the vehicle is not cooled by the second cooler 64.

The hot water, which has passed through the second heater core 63, flows to the first line switching valve 91, and the first line switching valve 91 sends the hot water to the hot water flow switching line L142. In this case, the first line switching valve 91 closes the second hot water supply line L122 directed toward the floor heat exchanger 80, such that the hot water is not supplied to the floor heat exchanger 80. Therefore, the cabin floor is not heated, and the hot water returns to the heat pump system 20 through the hot water return line L132.

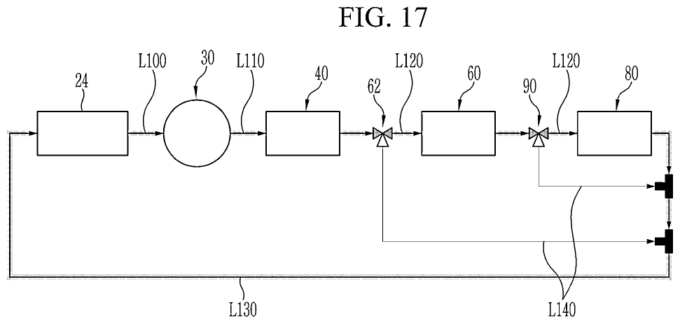

Hereinafter, a case in which the first air conditioning device and the second air conditioning device of the cabin cooling/heating system for a vehicle according to another embodiment of the present disclosure are used to cool or heat the cabin and the floor heat exchanger is used to cool or heat the cabin floor is described with reference to FIG. 17.

FIG. 17 is a schematic block diagram illustrating the case in which the first air conditioning device and the second air conditioning device of the cabin cooling/heating system for a vehicle according to another embodiment of the present disclosure are used to cool or heat the cabin, and a floor heat exchanger is used to cool or heat the cabin floor.

As illustrated in FIG. 17, in order to cool or heat the cabin by using the first air conditioning device 40 and the second air conditioning device 60 of the cabin cooling/heating system for a vehicle and to cool or heat the cabin floor by using the floor heat exchanger 80, the heat pump heat exchanger 24 provides the cold or hot water by exchanging heat with the refrigerant, and the water pump module 30 sends the provided cold or hot water to the air conditioning device 40 through the first supply line module L110 by pumping the cold or hot water through the first suction line module L100. The air conditioning device 40 provides the cold air or the warm air by exchanging heat between the cold water and the air or between the hot water and the air and cools or heats the cabin by blowing the cold air or the warm air into the front cabin 12. In addition, the cold or hot water, which has exchanged heat with the air, flows to the second air conditioning device 60 through the second supply line module L120. The second air conditioning device 60 provides the cold air or the warm air by exchanging heat between the cold water and the air or between the hot water and the air and cools or heats the cabin by blowing the cold air or the warm air into the rear cabin 14. The line switching valve module 90 connects the second air conditioning device 60 to the floor heat exchanger 80, such that the cold or hot water, which has flowed to the second air conditioning device 60, flows to the floor heat exchanger 80 through the second supply line module L120. The cold or hot water, which has flowed to the floor heat exchanger 80, cools or heats the cabin floor while circulating through the floor heat exchanger 80. The cold or hot water, which has circulated through the floor heat exchanger 80, returns back to the heat pump heat exchanger 24 through the return line module L130.

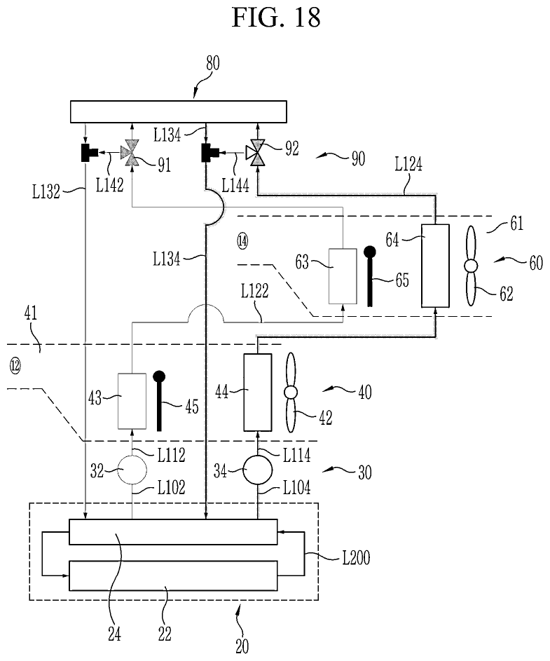

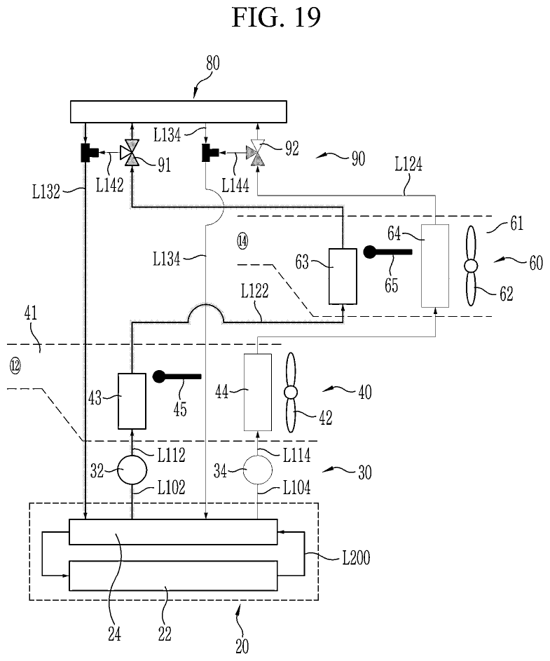

Hereinafter, the case in which the first air conditioning device and the second air conditioning device of the cabin cooling/heating system for a vehicle according to another embodiment of the present disclosure are used to cool or heat the cabin and the floor heat exchanger is used to cool or heat the cabin floor is described in more detail with reference to FIGS. 18 and 19.

FIG. 18 is a schematic configuration view illustrating a case in which the first air conditioning device and the second air conditioning device of the cabin cooling/heating system for a vehicle according to another embodiment of the present disclosure are used to cool the cabin, and the floor heat exchanger is used to cool the cabin floor. FIG. 19 is a schematic configuration view illustrating a case in which the first air conditioning device and the second air conditioning device of the cabin cooling/heating system for a vehicle according to another embodiment of the present disclosure are used to heat the cabin, and the floor heat exchanger is used to heat the cabin floor.

As illustrated in FIG. 18, in order to cool the cabin by using the first air conditioning device 40 and the second air conditioning device 60 of the cabin cooling/heating system for a vehicle and cool the cabin floor by using the floor heat exchanger 80, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. Therefore, the cold air is blown to the front cabin 12 through the air conditioning device 40 to cool the cabin. The hot water is not supplied to the heater core 43, and the air door 45 closes the air passageway 41 directed toward the heater core 43, such that the inside or outside air of the vehicle is not heated by the heater core 43.

The cold water, which has passed through the cooler 44, flows to the second cooler 64, the second air blower 62 blows the inside or outside air of the vehicle to the second air passageway 61, and the inside or outside air of the vehicle is cooled to become the cold air by the cold water passing through the second cooler 64. The hot water is not supplied to the second heater core 63, and the second air door 65 closes the second air passageway 61, such that the inside or outside air of the vehicle is not heated by the second heater core 63. Therefore, the cold air is blown to the rear cabin 14 through the second air conditioning device 60 to cool the cabin.

The cold water, which has passed through the second cooler 64, flows to the second line switching valve 92, and the second line switching valve 92 sends the cold water to the floor heat exchanger 80. The cold water cools the cabin floor while circulating through the floor heat exchanger 80 and returns to the heat pump system 20 through the cold water return line L134.

As illustrated in FIG. 19, in order to heat the cabin by using the air conditioning device 40 of the cabin cooling/heating system for a vehicle, the heat pump system 20 provides the hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the second heater core 63, the second air blower 62 blows the inside or outside air of the vehicle to the second air passageway 61, and the inside or outside air of the vehicle is heated to become the warm air by the hot water passing through the second heater core 63. The warm air is supplied to the rear cabin 14 to heat the cabin. In this case, because the cold water is not supplied to the second cooler 64, the inside or outside air of the vehicle is not cooled by the second cooler 64.

The hot water, which has passed through the second heater core 63, flows to the first line switching valve 91, and the first line switching valve 91 sends the hot water to the floor heat exchanger 80. The hot water heats the cabin floor while circulating through the floor heat exchanger 80 and returns to the heat pump system 20 through the hot water return line L132.

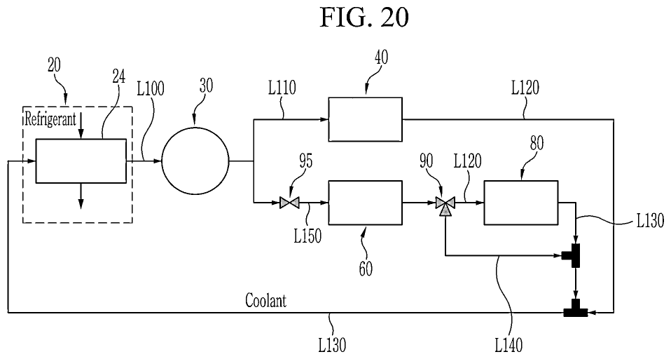

FIG. 20 is a schematic block diagram of the cabin cooling/heating system for a vehicle according to still another embodiment of the present disclosure.

As illustrated in FIG. 20, the cabin cooling/heating system for a vehicle according to still another embodiment of the present disclosure includes the heat pump system 20, the water pump module 30, the air conditioning device 40, the second air conditioning device 60, and the floor heat exchanger 80.

The heat pump system 20 includes the heat pump heat exchanger 24. The heat pump heat exchanger 24 provides the cold or hot water by exchanging heat between the water and the refrigerant.

The water pump module 30 is fluidly connected to the heat pump system 20 through the first suction line module L100 and configured to pump the cold or hot water from the heat pump system 20. The water pump module 30 is connected to the air conditioning device 40 through the first supply line module L110 and configured to allow the pumped cold or hot water to pass through the air conditioning device 40.

The air conditioning device 40 is fluidly connected to the water pump module 30 through the first supply line module L110 and receives the cold or hot water pumped by the water pump module 30. The air conditioning device 40 provides the cold air or the warm air by exchanging heat between the cold water and the air or between the hot water and the air. As illustrated in FIG. 9, the air conditioning device 40 is mounted in the front cabin 12 and configured to cool or heat the cabin by blowing the cold air or warm air into the front cabin 12. The air conditioning device 40 is fluidly connected to the second supply line module L120, such that the cold or hot water, which has passed through the air conditioning device 40, flows to the second supply line module L120. FIG. 20 illustrates that the second supply line module L120 is connected directly to the return line module L130. However, it should be understood that this configuration is merely provided for the convenience of description. It should be understood that the second supply line module L120 is connected to the return line module L130 selectively through the floor heat exchanger 80 or the flow switching line module L140.

The second air conditioning device 60 is fluidly connected to the water pump module 30 through a third supply line module L150 and receives the cold or hot water pumped by the water pump module 30. The second air conditioning device 60 also provides the cold air or the warm air by exchanging heat between the cold water and the air or between the hot water and the air. As illustrated in FIG. 9, the second air conditioning device 60 is mounted in the rear cabin 14 and configured to cool or heat the cabin by blowing the cold air or warm air into the rear cabin 14.

The floor heat exchanger 80 is fluidly connected to the second air conditioning device 60 through the second supply line module L120 and configured to receive the cold or hot water from the second air conditioning device 60. As illustrated in FIG. 9, the floor heat exchanger 80 is mounted in the cabin floor of the rear cabin 14 and configured to cool or heat the cabin floor of the rear cabin 14 by circulating the cold or hot water supplied from the second air conditioning device 60. The floor heat exchanger 80 is connected to the return line module L130, such that the cold or hot water, which has circulated through the floor heat exchanger 80, returns to the heat pump system 20 through the return line module L130.

The cabin cooling/heating system for a vehicle further includes a line addition valve module 95 and the line switching valve module 90.

The line addition valve module 95 is mounted in the third supply line module L150 that connects the water pump module 30 and the second air conditioning device 60. The line addition valve module 95 selectively sends or does not send the cold or hot water, which is pumped by the water pump module 30, to the second air conditioning device 60 through the third supply line module L150. Therefore, the cold or hot water, which is pumped by the water pump module 30, is always supplied to the air conditioning device 40 but selectively supplied to the second air conditioning device 60 by the line addition valve module 95.

The line switching valve module 90 is mounted in the second supply line module L120 that connects the second air conditioning device 60 and the floor heat exchanger 80. The line switching valve module 90 is configured to send the cold or hot water from the second air conditioning device 60 to the floor heat exchanger 80 or the flow switching line module L140. In other words, the line switching valve module 90 selectively and fluidly connects the second air conditioning device 60 to the floor heat exchanger 80 or the flow switching line module L140. The flow switching line module L140 is fluidly connected to the return line module L130 while bypassing the floor heat exchanger 80. Therefore, the cold or hot water in the second air conditioning device 60 may flow to the return line module L130 while passing through the floor heat exchanger 80 or flow to the return line module L130 through the flow switching line module L140 without passing through the floor heat exchanger 80, depending on the switching operation of the line switching valve module 90.

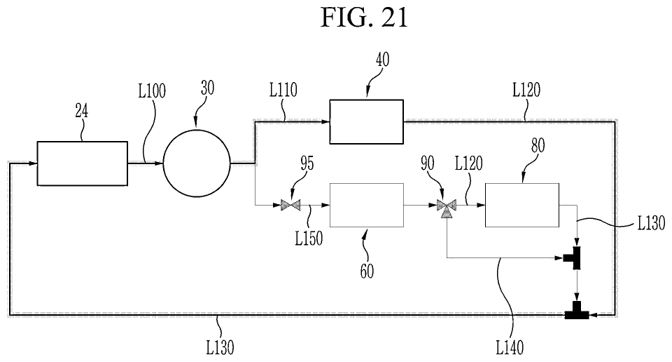

Hereinafter, a case in which the air conditioning device of the cabin cooling/heating system for a vehicle according to still another embodiment of the present disclosure is used to cool or heat the cabin is described with reference to FIG. 21.

FIG. 21 is a schematic block diagram illustrating a case in which the air conditioning device of the cabin cooling/heating system for a vehicle according to still another embodiment of the present disclosure is used to cool or heat the cabin.

As illustrated in FIG. 21, in order to cool or heat the cabin by using the air conditioning device 40 of the cabin cooling/heating system for a vehicle, the heat pump heat exchanger 24 provides the cold or hot water by exchanging heat with the refrigerant. The water pump module 30 sends the cold or hot water to the air conditioning device 40 through the first supply line module L110 by pumping the cold or hot water through the first suction line module L100. The air conditioning device 40 provides the cold air or the warm air by exchanging heat between the cold water and the air or between the hot water and the air and cools or heats the cabin by blowing the cold air or the warm air into the front cabin 12. The cold or hot water, which has passed through the air conditioning device 40, flows to the second supply line module L120 and then returns back to the heat pump heat exchanger 24 through the flow switching line module L140 and the return line module L130 by the line switching valve module 90.

In addition, the line addition valve module 95 closes the third supply line module L150, such that the cold or hot water pumped by the water pump module 30 is not supplied to the second air conditioning device 60.

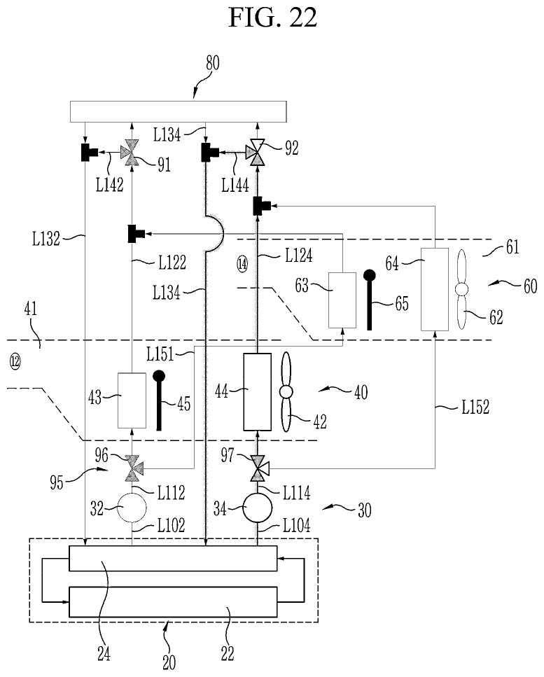

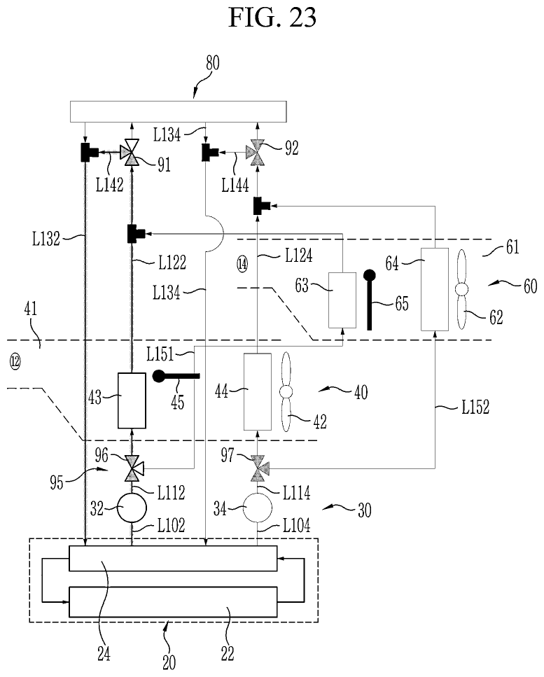

Hereinafter, the case in which the air conditioning device of the cabin cooling/heating system for a vehicle according to still another embodiment of the present disclosure is used to cool or heat the cabin is described in more detail with reference to FIGS. 22 and 23.

FIG. 22 is a configuration view illustrating a case in which the air conditioning device of the cabin cooling/heating system for a vehicle according to still another embodiment of the present disclosure is used to cool the cabin. FIG. 23 is a configuration view illustrating a case in which the air conditioning device of the cabin cooling/heating system for a vehicle according to still another embodiment of the present disclosure is used to heat the cabin.

As illustrated in FIGS. 22 and 23, the heat pump system 20 further includes the heat pump 22. The heat pump 22 may provide the hot water by supplying thermal energy to the water in the heat pump heat exchanger 24 by using the refrigerant circulating through the refrigerant circulation line L200 or provide the cold water by recovering thermal energy from the water in the heat pump heat exchanger 24.

The first suction line module L100 includes the first hot water suction line L102 and the first cold water suction line L104. The first hot water suction line L102 is connected to the hot water generation portion of the heat pump heat exchanger 24, and the hot water provided by the hot water generation portion of the heat pump heat exchanger 24 flows to the first hot water suction line L102. The first cold water suction line L104 is connected to the cold water generation portion of the heat pump heat exchanger 24, and the cold water provided by the cold water generation portion of the heat pump heat exchanger 24 flows to the first cold water suction line L104.

The water pump module 30 includes the first and second water pumps 32 and 34. The first water pump 32 is connected to the first hot water suction line L102 and pumps the hot water provided by the hot water generation portion of the heat pump heat exchanger 24. The second water pump 34 is connected to the first cold water suction line L104 and pumps the cold water provided by the cold water generation portion of the heat pump heat exchanger 24.

The first supply line module L110 includes the first hot water supply line L112 and the first cold water supply line L114. The first hot water supply line L112 is connected to the first water pump 32, such that the hot water pumped by the first water pump 32 flows to the first hot water supply line L112. The first cold water supply line L114 is connected to the second water pump 34, such that the cold water pumped by the second water pump 34 flows to the first cold water supply line L114.

The air conditioning device 40 includes the air passageway 41, and the heater core 43 and the cooler 44 disposed in the air passageway 41.

The air passageway 41 allows the inside or outside of the vehicle 10 to communicate with the front cabin 12 so that the air outside the vehicle 10 flows into the front cabin 12. The air blower 42 is disposed in the air passageway 41 and blows the inside or outside air of the vehicle into the air passageway 41. The drawings illustrate that the air blower 42 is disposed at the upstream side of the cooler 44. However, the air blower 42 may be disposed at any position at which the air blower 42 may send the inside or outside air of the vehicle to the front cabin 12 through the air passageway 41.

The heater core 43 is disposed in the air passageway 41 and configured to provide the warm air by heating the inside or outside air of the vehicle passing through the heater core 43 and supplying the warm air into the cabin, particularly the front cabin 12 to heat the cabin. The heater core 43 is connected to the first hot water supply line L112, receives the hot water pumped by the first water pump 32, and heats the inside or outside air of the vehicle, which passes through the heater core 43, by using the hot water. The air door 45 is mounted in the air passageway 41 through which the inside or outside air of the vehicle flows toward the heater core 43 from the outside of the vehicle 10. The air door 45 selectively opens or closes the air passageway 41 through which the inside or outside air of the vehicle flows toward the heater core 43. In other words, the air door 45 may close the air passageway 41, through which the inside or outside air of the vehicle flows toward the heater core 43, to prevent the inside or outside air of the vehicle from passing through the heater core 43. Alternatively, the air door 45 may open the air passageway 41, through which the inside or outside air of the vehicle flows toward the heater core 43, to allow the inside or outside air of the vehicle to pass through the heater core 43. Therefore, the inside or outside air of the vehicle is heated by the heater core 43 when the air door 45 opens the air passageway 41. The inside or outside air of the vehicle is not heated by the heater core 43 when the air door 45 closes the air passageway 41.

The cooler 44 is disposed in the air passageway 41 and configured to provide the cold air by cooling the inside or outside air of the vehicle passing through the cooler 44 and supplying the cold air into the cabin, particularly the front cabin 12 to cool the cabin. The cooler 44 is connected to the first cold water supply line L114, receives the cold water pumped by the second water pump 34, and cools the inside or outside air of the vehicle, which passes through the cooler 44, by using the cold water.

The second supply line module L120 includes the second hot water supply line L122 and the second cold water supply line L124. The second hot water supply line L122 is fluidly connected to the heater core 43, such that the hot water, which has exchanged heat with the inside or outside air of the vehicle while passing through the heater core 43, flows to the second hot water supply line L122. The second cold water supply line L124 is fluidly connected to the cooler 44, such that the cold water, which has exchanged heat with the inside or outside air of the vehicle while passing through the cooler 44, flows to the second cold water supply line L124.

In addition, the line addition valve module 95 is disposed in the first supply line module L110 and selectively and fluidly connects the first supply line module L110 to the third supply line module L150.

The line addition valve module 95 includes a first line addition valve 96 and a second line addition valve 97, and the third supply line module L150 includes a third hot water supply line L151 and a third cold water supply line L152. The first line addition valve 96 selectively connects the first hot water supply line L112 to the third hot water supply line L151 and sends or does not send a portion of the hot water, which flows along the first hot water supply line L112, to the third hot water supply line L151. The second line addition valve 97 selectively connects the first cold water supply line L114 to the third cold water supply line L152 and sends or does not send a portion of the cold water, which flows along the first cold water supply line L114, to the third cold water supply line L152.

The second air conditioning device 60 includes the second air passageway 61, the second heater core 63, and the second cooler 64 disposed in the second air passageway 61.

The second air passageway 61 allows the inside or outside of the vehicle 10 to communicate with the rear cabin 14 so that the air outside the vehicle 10 flows into the rear cabin 14. The second air blower 62 is disposed in the second air passageway 61 and blows the inside or outside air of the vehicle into the second air passageway 61.

The second heater core 63 is disposed in the second air passageway 61 and configured to provide the warm air by heating the inside or outside air of the vehicle passing through the second heater core 63 and supplying the warm air into the cabin, particularly the rear cabin 14 to heat the cabin. The second heater core 63 is connected to the third hot water supply line L151, receives a portion of the hot water pumped by the first water pump 32, and heats the inside or outside air of the vehicle, which passes through the second heater core 63, by using the hot water. The second air door 65 is mounted in the second air passageway 61 through which the inside or outside air of the vehicle flows toward the second heater core 63 from the outside of the vehicle 10. The second air door 65 selectively opens or closes the second air passageway 61 through which the inside or outside air of the vehicle flows toward the second heater core 63. In other words, the second air door 65 may close the second air passageway 61, through which the inside or outside air of the vehicle flows toward the second heater core 63, to prevent the inside or outside air of the vehicle from passing through the second heater core 63. Alternatively, the second air door 65 may open the second air passageway 61, through which the inside or outside air of the vehicle flows toward the second heater core 63, to allow the inside or outside air of the vehicle to pass through the second heater core 63. Therefore, the inside or outside air of the vehicle is heated by the second heater core 63 when the second air door 65 opens the second air passageway 61. The inside or outside air of the vehicle is not heated by the second heater core 63 when the second air door 65 closes the second air passageway 61.

The second cooler 64 is disposed in the second air passageway 61 and configured to provide the cold air by cooling the inside or outside air of the vehicle passing through the second cooler 64 and supplying the cold air into the cabin, particularly the rear cabin 14 to cool the cabin. The second cooler 64 is connected to the third cold water supply line L152, receives a portion of the cold water pumped by the second water pump 34, and cools the inside or outside air of the vehicle, which passes through the second cooler 64, by using the cold water.

The line switching valve module 90 includes the first line switching valve 91 and the second line switching valve 92. The first line switching valve 91 is fluidly connected to the second hot water supply line L122, such that the hot water, which has passed through the heater core 43 or the second heater core 63, flows to the first line switching valve 91. The first line switching valve 91 is selectively connected to the floor heat exchanger 80 or the hot water flow switching line L142 of the flow switching line module L140, such that the hot water selectively flows to the floor heat exchanger 80 or the hot water flow switching line L142. The second line switching valve 92 is fluidly connected to the second cold water supply line L124, such that the cold water, which has passed through the cooler 44 or the second cooler 64, flows to the second line switching valve 92. The second line switching valve 92 is selectively connected to the floor heat exchanger 80 or the cold water flow switching line L144 of the flow switching line module L140, such that the cold water selectively flows to the floor heat exchanger 80 or the cold water flow switching line L144.

The return line module L130 includes the hot water return line L132 and the cold water return line L134. The hot water return line L132 is fluidly connected to the floor heat exchanger 80 and the hot water flow switching line L142. Therefore, the hot water having circulated through the floor heat exchanger 80 or the hot water having flowed to the hot water flow switching line L142 by the first line switching valve 91 returns to the heat pump system 20 through the hot water return line L132. The cold water return line L134 is fluidly connected to the floor heat exchanger 80 and the cold water flow switching line L144. Therefore, the cold water having circulated through the floor heat exchanger 80 or the cold water having flowed to the cold water flow switching line L144 by the second line switching valve 92 returns to the heat pump system 20 through the cold water return line L134.

As illustrated in FIG. 22, in order to cool the cabin by using the air conditioning device 40 of the cabin cooling/heating system for a vehicle, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. The hot water is not supplied to the heater core 43, and the air door 45 closes the air passageway 41 directed toward the heater core 43, such that the inside or outside air of the vehicle is not heated by the heater core 43. Therefore, the cold air is blown to the front cabin 12 through the air conditioning device 40 to cool the cabin.

The cold water, which has passed through the cooler 44, flows to the second line switching valve 92 through the second cold water supply line L124, and the second line switching valve 92 sends the cold water to the cold water flow switching line L144. In this case, the second line switching valve 92 closes the second cold water supply line L124 directed toward the floor heat exchanger 80, such that the cold water is not supplied to the floor heat exchanger 80. Therefore, the cabin floor is not cooled, and the cold water returns to the heat pump system 20 through the cold water return line L134.

In addition, the second line addition valve 97 does not connect the first cold water supply line L114 to the third cold water supply line L152, such that the cold water does not flow to the second cooler 64.

As illustrated in FIG. 23, in order to heat the cabin by using the air conditioning device 40 of the cabin cooling/heating system for a vehicle, the heat pump system 20 provides the hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the first line switching valve 91 through the second hot water supply line L122, and the first line switching valve 91 sends the hot water to the hot water flow switching line L142. In this case, the first line switching valve 91 closes the second hot water supply line L122 directed toward the floor heat exchanger 80, such that the hot water is not supplied to the floor heat exchanger 80. Therefore, the cabin floor is not heated, and the hot water returns to the heat pump system 20 through the hot water return line L132.

In addition, the first line addition valve 96 does not connect the first hot water supply line L112 to the third hot water supply line L151, such that the hot water does not flow to the second heater core 63.

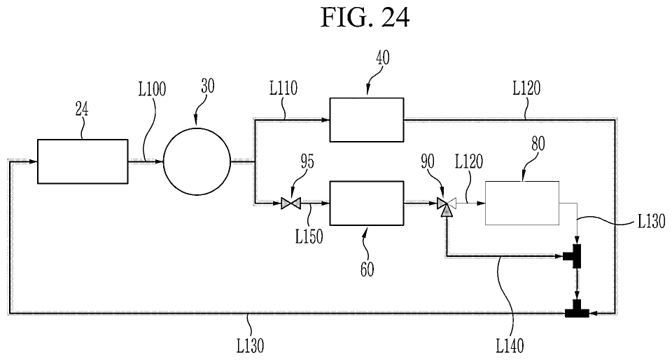

Hereinafter, a case in which the first air conditioning device and the second air conditioning device of the cabin cooling/heating system for a vehicle according to still another embodiment of the present disclosure are used to cool or heat the cabin is described with reference to FIG. 24.

FIG. 24 is a schematic block diagram illustrating a case in which the first air conditioning device and a second air conditioning device of the cabin cooling/heating system for a vehicle according to still another embodiment of the present disclosure are used to cool or heat the cabin.

As illustrated in FIG. 24, in order to cool or heat the cabin by using the first air conditioning device 40 and the second air conditioning device 60 of the cabin cooling/heating system for a vehicle, the heat pump heat exchanger 24 provides the cold or hot water by exchanging heat with the refrigerant, and the water pump module 30 sends the cold or hot water to the air conditioning device 40 through the first supply line module L110 by pumping the cold or hot water through the first suction line module L100. The air conditioning device 40 provides the cold air or the warm air by exchanging heat between the cold water and the air or between the hot water and the air and cools or heats the cabin by blowing the cold air or the warm air into the front cabin 12. The cold or hot water, which has passed through the air conditioning device 40, flows to the second supply line module L120.

In addition, the line addition valve module 95 connects the first supply line module L110 to the third supply line module L150, such that a portion of the cold or hot water provided in the water pump module 30 flows to the second air conditioning device 60. The second air conditioning device 60 provides the cold air or the warm air by exchanging heat between the cold water and the air or between the hot water and the air and cools or heats the cabin by blowing the cold air or the warm air into the rear cabin 14. The cold or hot water, which has passed through the second air conditioning device 60, flows to the second supply line module L120, flows to the flow switching line module L140 by the line switching valve module 90 together with the cold or hot water having passed through the air conditioning device 40, and returns back to the heat pump heat exchanger 24 through the return line module L130.

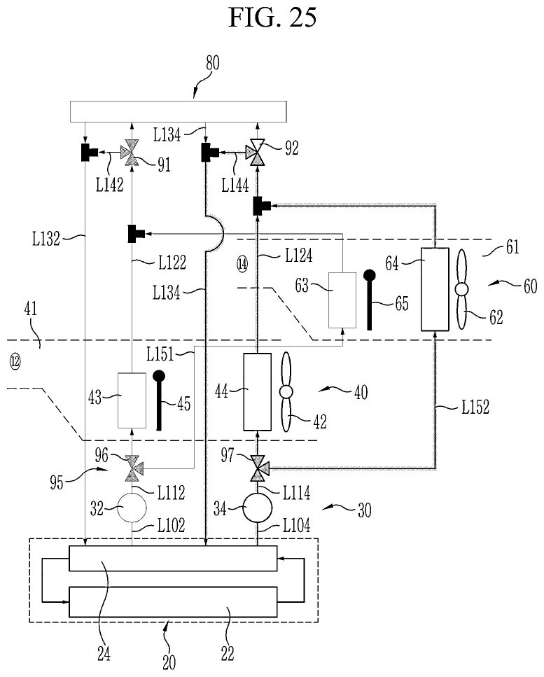

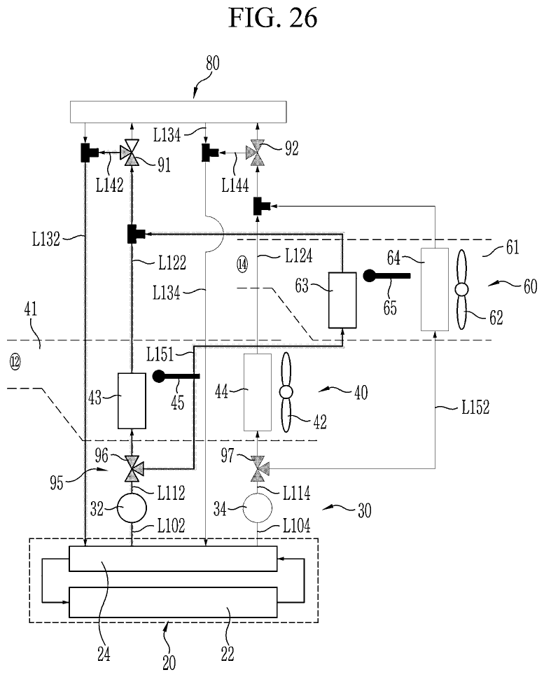

Hereinafter, the case in which the first air conditioning device and the second air conditioning device of the cabin cooling/heating system for a vehicle according to another embodiment of the present disclosure are used to cool or heat the cabin is described in more detail with reference to FIGS. 25 and 26.

FIG. 25 is a configuration view illustrating a case in which the first air conditioning device and the second air conditioning device of the cabin cooling/heating system for a vehicle according to still another embodiment of the present disclosure are used to cool the cabin. FIG. 26 is a configuration view illustrating a case in which the first air conditioning device and the second air conditioning device of the cabin cooling/heating system for a vehicle according to still another embodiment of the present disclosure are used to heat the cabin.

As illustrated in FIG. 25, in order to cool the cabin by using the first air conditioning device 40 and the second air conditioning device 60 of the cabin cooling/heating system for a vehicle, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. Therefore, the cold air is blown to the front cabin 12 through the air conditioning device 40 to cool the cabin. The hot water is not supplied to the heater core 43, and the air door 45 closes the air passageway 41 directed toward the heater core 43, such that the inside or outside air of the vehicle is not heated by the heater core 43.

The cold water, which has passed through the cooler 44, flows to the second line switching valve 92 through the second cold water supply line L124, and the second line switching valve 92 sends the cold water to the cold water flow switching line L144. In this case, the second line switching valve 92 closes the second cold water supply line L124 directed toward the floor heat exchanger 80, such that the cold water is not supplied to the floor heat exchanger 80. Therefore, the cabin floor is not cooled, and the cold water returns to the heat pump system 20 through the cold water return line L134.

In addition, the second line addition valve 97 disposed in the first cold water supply line L114 connects the first cold water supply line L114 to the third cold water supply line L152, such that a portion of the cold water in the first cold water supply line L114 flows to the second cooler 64. In this case, the second air blower 62 blows the inside or outside air of the vehicle to the second air passageway 61, and the inside or outside air of the vehicle is cooled to become the cold air by the cold water passing through the second cooler 64. The hot water is not supplied to the second heater core 63, and the second air door 65 closes the second air passageway 61, such that the inside or outside air of the vehicle is not heated by the second heater core 63. Therefore, the cold air is blown to the rear cabin 14 through the second air conditioning device 60 to cool the cabin.

The cold water, which has passed through the second cooler 64, flows to the second line switching valve 92 through the second cold water supply line L124, and the second line switching valve 92 sends the cold water, which has passed through the second cooler 64, to the cold water flow switching line L144 together with the cold water having passed through the cooler 44. In this case, the second line switching valve 92 closes the second cold water supply line L124 directed toward the floor heat exchanger 80, such that the cold water is not supplied to the floor heat exchanger 80. Therefore, the cabin floor is not cooled, and the cold water returns to the heat pump system 20 through the cold water return line L134.

As illustrated in FIG. 26, in order to heat the cabin by using the first air conditioning device 40 and the second air conditioning device 60 of the cabin cooling/heating system for a vehicle, the heat pump system 20 provides the hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44.

The hot water, which has passed through the heater core 43, flows to the first line switching valve 91 through the second hot water supply line L122, and the first line switching valve 91 sends the hot water to the hot water flow switching line L142. In this case, the first line switching valve 91 closes the second hot water supply line L122 directed toward the floor heat exchanger 80, such that the hot water is not supplied to the floor heat exchanger 80. Therefore, the cabin floor is not heated, and the hot water returns to the heat pump system 20 through the hot water return line L132.

In addition, the first line addition valve 96 disposed in the first hot water supply line L112 connects the first hot water supply line L112 to the third hot water supply line L151, such that a portion of the hot water of the first hot water supply line L112 flows to the second heater core 63. In this case, the second air blower 62 blows the inside or outside air of the vehicle to the second air passageway 61, and the second air door 65 opens the second air passageway 61 directed toward the second heater core 63, such that the inside or outside air of the vehicle is heated to become the warm air by the hot water passing through the second heater core 63. The warm air is supplied to the rear cabin 14 to heat the cabin. In this case, because the cold water is not supplied to the second cooler 64, the inside or outside air of the vehicle is not cooled by the second cooler 64.

The hot water, which has passed through the second heater core 63, flows to the first line switching valve 91 through the second hot water supply line L122, and the first line switching valve 91 sends the hot water, which has passed through the second heater core 63, to the hot water flow switching line L142 together with the hot water having passed through the heater core 43. In this case, the first line switching valve 91 closes the second hot water supply line L122 directed toward the floor heat exchanger 80, such that the hot water is not supplied to the floor heat exchanger 80. Therefore, the cabin floor is not heated, and the hot water returns to the heat pump system 20 through the hot water return line L132.

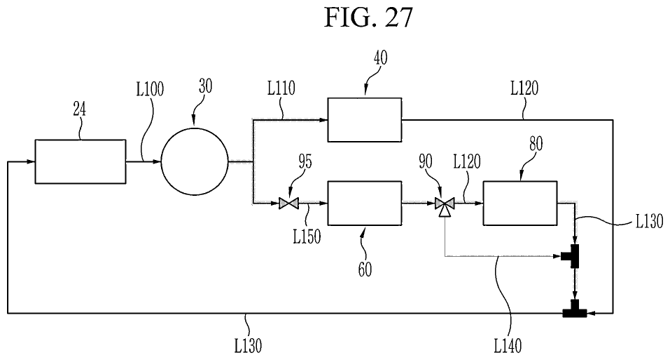

Hereinafter, a case in which the first air conditioning device and the second air conditioning device of the cabin cooling/heating system for a vehicle according to still another embodiment of the present disclosure are used to cool or heat the cabin and the floor heat exchanger is used to cool or heat the cabin floor is described with reference to FIG. 27.

FIG. 27 is a schematic block diagram illustrating the case in which the first air conditioning device and the second air conditioning device of the cabin cooling/heating system for a vehicle according to still another embodiment of the present disclosure are used to cool or heat the cabin, and the floor heat exchanger is used to cool or heat the cabin floor.

As illustrated in FIG. 27, in order to cool or heat the cabin by using the first air conditioning device 40 and the second air conditioning device 60 of the cabin cooling/heating system for a vehicle and to cool or heat the cabin floor by using the floor heat exchanger 80, the heat pump heat exchanger 24 provides the cold or hot water by exchanging heat with the refrigerant, and the water pump module 30 sends the cold or hot water to the air conditioning device 40 through the first supply line module L110 by pumping the cold or hot water through the first suction line module L100. The air conditioning device 40 provides the cold air or the warm air by exchanging heat between the cold water and the air or between the hot water and the air and cools or heats the cabin by blowing the cold air or warm air into the front cabin 12. The cold or hot water, which has passed through the air conditioning device 40, flows to the second supply line module L120.

In addition, the line addition valve module 95 connects the first supply line module L110 to the third supply line module L150, such that a portion of the cold or hot water in the water pump module 30 flows to the second air conditioning device 60. The second air conditioning device 60 provides the cold air or the warm air by exchanging heat between the cold water and the air or between the hot water and the air and cools or heats the cabin by blowing the cold air or the warm air into the rear cabin 14. The cold or hot water, which has passed through the second air conditioning device 60, flows to the second supply line module L120 and flows to the floor heat exchanger 80 by the line switching valve module 90 together with the cold or hot water having passed through the air conditioning device 40. The cold or hot water, which has flowed to the floor heat exchanger 80, cools or heats the cabin floor while circulating through the floor heat exchanger 80. The cold or hot water, which has circulated through the floor heat exchanger 80, returns back to the heat pump heat exchanger 24 through the return line module L130.

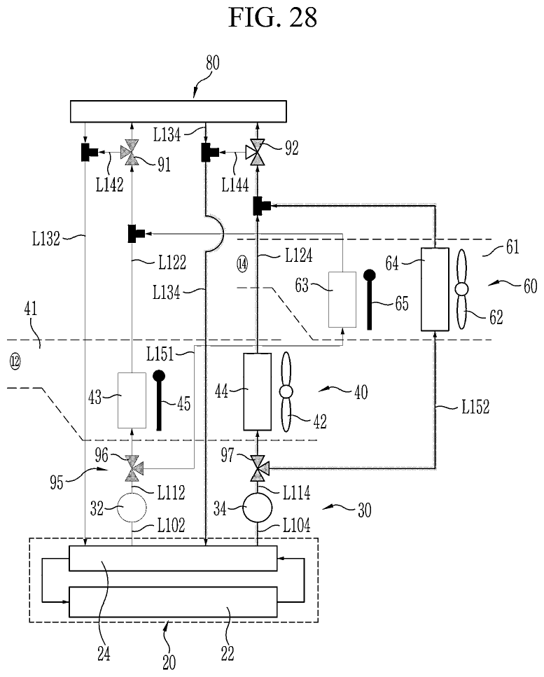

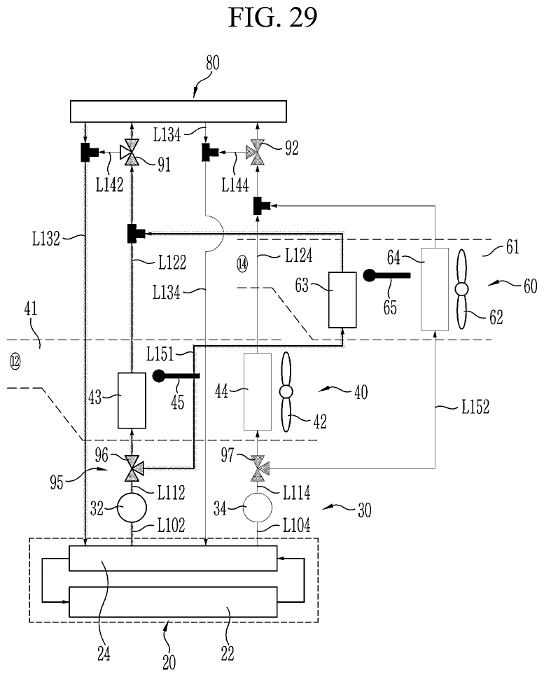

Hereinafter, the case in which the air conditioning device and the second air conditioning device of the cabin cooling/heating system for a vehicle according to still another embodiment of the present disclosure are used to cool or heat the cabin, and the floor heat exchanger is used to cool or heat the cabin floor is described in more detail with reference to FIGS. 28 and 29.

FIG. 28 is a configuration view illustrating a case in which the first air conditioning device and the second air conditioning device of the cabin cooling/heating system for a vehicle according to still another embodiment of the present disclosure are used to cool the cabin, and the floor heat exchanger is used to cool the cabin floor. FIG. 29 is a configuration view illustrating a case in which the first air conditioning device and the second air conditioning device of the cabin cooling/heating system for a vehicle according to still another embodiment of the present disclosure are used to heat the cabin, and the floor heat exchanger is used to heat the cabin floor.

As illustrated in FIG. 28, in order to cool the cabin by using the first air conditioning device 40 and the second air conditioning device 60 of the cabin cooling/heating system for a vehicle and cool the cabin floor by using the floor heat exchanger 80, the heat pump system 20 provides the cold water by using the refrigerant circulating through the refrigerant circulation line L200. The second water pump 34 sends the cold water to the cooler 44 by pumping the cold water. The air blower 42 blows the inside or outside air of the vehicle to the air passageway 41, and the inside or outside air of the vehicle is cooled to become the cold air by the cold water passing through the cooler 44. Therefore, the cold air is blown to the front cabin 12 through the air conditioning device 40 to cool the cabin. The hot water is not supplied to the heater core 43, and the air door 45 closes the air passageway 41 directed toward the heater core 43, such that the inside or outside air of the vehicle is not heated by the heater core 43. The cold water, which has passed through the cooler 44, flows to the second line switching valve 92 through the second cold water supply line L124.

In addition, the second line addition valve 97 disposed in the first cold water supply line L114 connects the first cold water supply line L114 to the third cold water supply line L152, such that a portion of the cold water in the first cold water supply line L114 flows to the second cooler 64. In this case, the second air blower 62 blows the inside or outside air of the vehicle to the second air passageway 61, and the inside or outside air of the vehicle is cooled to become the cold air by the cold water passing through the second cooler 64. The hot water is not supplied to the second heater core 63, and the second air door 65 closes the second air passageway 61, such that the inside or outside air of the vehicle is not heated by the second heater core 63. Therefore, the cold air is blown to the rear cabin 14 through the second air conditioning device 60 to cool the cabin.

The cold water, which has passed through the second cooler 64, flows to the second line switching valve 92 through the second cold water supply line L124, and the second line switching valve 92 sends the cold water, which has passed through the second cooler 64, to the floor heat exchanger 80 together with the cold water having passed through the cooler 44. The cold water cools the cabin floor while circulating through the floor heat exchanger 80 and returns to the heat pump system 20 through the cold water return line L134.

As illustrated in FIG. 29, in order to heat the cabin by using the air conditioning device 40 of the cabin cooling/heating system for a vehicle and heat the cabin floor by using the floor heat exchanger 80, the heat pump system 20 provides the hot water by using the refrigerant circulating through the refrigerant circulation line L200. The first water pump 32 sends the hot water to the heater core 43 by pumping the hot water. The air blower 42 blows the inside or outside air of the vehicle to the air passageway 41, and the air door 45 opens the air passageway 41 directed toward the heater core 43, such that the inside or outside air of the vehicle is heated to become the warm air by the hot water passing through the heater core 43. The warm air is supplied to the front cabin 12 to heat the cabin. In this case, because the cold water is not supplied to the cooler 44, the inside or outside air of the vehicle is not cooled by the cooler 44. The hot water, which has passed through the heater core 43, flows to the first line switching valve 91 through the second hot water supply line L122.

In addition, the first line addition valve 96 disposed in the first hot water supply line L112 connects the first hot water supply line L112 to the third hot water supply line L151, such that a portion of the hot water of the first hot water supply line L112 flows to the second heater core 63. In this case, the second air blower 62 blows the inside or outside air of the vehicle to the second air passageway 61, and the inside or outside air of the vehicle is heated to become the warm air by the hot water passing through the second heater core 63. The warm air is blown to the rear cabin 14 through the second air conditioning device 60 and heats the cabin. In this case, because the cold water is not supplied to the second cooler 64, the inside or outside air of the vehicle is not cooled by the second cooler 64.

The hot water, which has passed through the second heater core 63, flows to the first line switching valve 91 through the second hot water supply line L122, and the first line switching valve 91 sends the hot water, which has passed through the second heater core 63, to the floor heat exchanger 80 together with the hot water having passed through the heater core 43. The hot water heats the cabin floor while circulating through the floor heat exchanger 80 and returns to the heat pump system 20 through the hot water return line L132.

While the embodiments of the present disclosure have been described, the present disclosure is not limited to the embodiments. The present disclosure covers all modifications that can be easily made from the embodiments of the present disclosure by those having ordinary skill in the art and considered as being equivalent to the present disclosure.

What is claimed is:

1. A cabin cooling/heating system for a vehicle, the vehicle including a front cabin, a rear cabin, and a cabin floor of the rear cabin,
the cabin cooling/heating system comprising:
a heat pump system configured to provide cold or hot water by circulating a refrigerant;
an air conditioning device fluidly connected to the heat pump system and configured to:
receive the cold or hot water from the heat pump system,
provide cold air or warm air by exchanging heat between inside air or outside air of the vehicle and the cold or hot water, and
blow the cold air or the warm air to the front cabin;
a floor heat exchanger mounted in the cabin floor and fluidly connected to the air conditioning device, wherein the floor heat exchanger is configured to receive the cold or hot water from the air conditioning device, and cool or heat the cabin floor by circulating the cold or hot water through the cabin floor; and
a line switching valve module disposed between the air conditioning device and the floor heat exchanger and configured to send the cold or hot water, which has passed through the air conditioning device, to the floor heat exchanger or return the cold or hot water back to the heat pump system,
wherein the cold or hot water, which has circulated through the floor heat exchanger, returns back to the heat pump system.

2. The cabin cooling/heating system of claim 1, further comprising a water pump module fluidly connected to the heat pump system and configured to pump the cold or hot water to the heat pump system.

3. The cabin cooling/heating system of claim 1, wherein the heat pump system comprises:
a heat pump heat exchanger configured to provide the cold or hot water by allowing water to exchange heat with the refrigerant; and
a heat pump configured to provide the hot water by supplying thermal energy to the water in the heat pump heat exchanger by circulating the refrigerant via a refrigerant circulation line or provide the cold water by recovering thermal energy from the water in the heat pump heat exchanger,
wherein the air conditioning device includes:
an air passageway configured to allow the inside air or the outside air of the vehicle to communicate with the front cabin, the air passageway defining a passageway through which the inside air or the outside air of the vehicle flows to the front cabin,
an air blower configured to blow the inside air or the outside air of the vehicle into the air passageway,
a heater core disposed in the air passageway and configured to receive the hot water from the heat pump heat exchanger and heat the inside air or the outside air of the vehicle in the air passageway, and
a cooler disposed in the air passageway and configured to receive the cold water from the heat pump heat exchanger and cool the inside air or the outside air of the vehicle in the air passageway, and
wherein the line switching valve module includes:
a first line switching valve fluidly connected to the heater core and configured to receive the hot water from the heater core and selectively send the hot water to the floor heat exchanger or the heat pump heat exchanger, and
a second line switching valve fluidly connected to the cooler and configured to receive the cold water from the cooler and selectively send the cold water to the floor heat exchanger or the heat pump heat exchanger.

4. The cabin cooling/heating system of claim 3, wherein the air conditioning device further comprises an air door configured to selectively open or close the air passageway through which the inside air or the outside air of the vehicle flows to the heater core.

5. The cabin cooling/heating system of claim 1, wherein the air conditioning device is configured to cool or heat the front cabin in response to an operation of the cabin cooling/heating system, and wherein whether to cool or heat the cabin floor by the floor heat exchanger is controlled by the line switching valve module.

6. A cabin cooling/heating system for a vehicle, the vehicle including a front cabin, a rear cabin, and a cabin floor, the cabin cooling/heating system comprising:
a heat pump system configured to provide cold or hot water by circulating a refrigerant;
an air conditioning device fluidly connected to the heat pump system and configured to:
receive the cold or hot water from the heat pump system,
provide cold or warm air by exchanging heat between inside air or outside air of the vehicle and the cold or hot water, and
blow the cold air or the warm air to the front cabin;
a second air conditioning device fluidly connected to the air conditioning device and configured to:
receive the cold or hot water from the air conditioning device,
provide the cold or warm air by exchange heat between the inside air or the outside air of the vehicle and the cold or hot water, and
blow the cold air or the warm air to the rear cabin;
a floor heat exchanger mounted in the cabin floor and fluidly connected to the second air conditioning device, wherein the floor heat exchanger is configured to receive the cold or hot water from the second air conditioning device, and configured to cool or heat the cabin floor by circulating the cold or hot water through the cabin floor; and
a line switching valve module disposed between the second air conditioning device and the floor heat exchanger and configured to send the cold or hot water, which has passed through the second air conditioning device, to the floor heat exchanger or return the cold or hot water back to the heat pump system,
wherein the cold or hot water, which has circulated through the floor heat exchanger, returns back to the heat pump system.

7. The cabin cooling/heating system of claim 6, further comprising a water pump module fluidly connected to the heat pump system and configured to pump the cold or hot water to the heat pump system.

8. The cabin cooling/heating system of claim 6, wherein the heat pump system comprises:
a heat pump heat exchanger configured to provide the cold or hot water by allowing water to exchange heat with the refrigerant; and
a heat pump configured to provide the hot water by supplying thermal energy to the water in the heat pump heat exchanger by circulating the refrigerant via a refrigerant circulation line, or configured to provide the cold water by recovering thermal energy from the water in the heat pump heat exchanger,
wherein the air conditioning device comprises:
an air passageway configured to allow the inside air or the outside air of the vehicle to communicate with the front cabin, the air passageway defining a passageway through which the inside air or the outside air of the vehicle flows to the front cabin;
an air blower configured to blow the inside air or the outside air of the vehicle into the air passageway;
a heater core disposed in the air passageway and configured to receive the hot water from the heat pump heat exchanger and heat the inside air or the outside air of the vehicle in the air passageway; and
a cooler disposed in the air passageway and configured to receive the cold water from the heat pump heat exchanger and cool the inside air or the outside air of the vehicle in the air passageway,
wherein the second air conditioning device comprises:
a second air passageway configured to allow the inside air or the outside air of the vehicle to communicate with the rear cabin, the second air passageway defining a passageway through which the inside air or the outside air of the vehicle flows to the rear cabin;
a second air blower configured to blow the inside air or the outside air of the vehicle into the second air passageway;
a second heater core disposed in the second air passageway and configured to receive the hot water from the heater core and heat the inside air or the outside air of the vehicle in the second air passageway; and
a second cooler disposed in the second air passageway and configured to receive the cold water from the cooler and cool the inside air or the outside air of the vehicle in the second air passageway, and
wherein the line switching valve module comprises:
a first line switching valve fluidly connected to the second heater core and configured to receive the hot water from the second heater core and selectively send the hot water to the floor heat exchanger or the heat pump heat exchanger; and
a second line switching valve fluidly connected to the second cooler and configured to receive the cold water from the second cooler and selectively send the cold water to the floor heat exchanger or the heat pump heat exchanger.

9. The cabin cooling/heating system of claim 8, wherein the air conditioning device further comprises an air door configured to selectively open or close the air passageway through which the inside air or the outside air of the vehicle flows to the heater core, and
wherein the second air conditioning device further comprises a second air door configured to selectively open or close the second air passageway through which the inside air or the outside air of the vehicle flows to the second heater core.

10. The cabin cooling/heating system of claim 8, wherein the second air conditioning device communicates with the air conditioning device, and
wherein the rear cabin is cooled or heated when the second air blower operates.

11. The cabin cooling/heating system of claim 6, wherein the air conditioning device cools or heats the front cabin in response to an operation of the cabin cooling/heating system for a vehicle, and
wherein whether to cool or heat the cabin floor by the floor heat exchanger is controlled by the line switching valve module.

12. A cabin cooling/heating system for a vehicle, the vehicle including a front cabin, a rear cabin, and a cabin floor of the rear cabin,
the cabin cooling/heating system comprising:
a heat pump system configured to provide cold or hot water by circulating a refrigerant;
an air conditioning device fluidly connected to the heat pump system and configured to receive:
the cold or hot water from the heat pump system,
provide cold or warm air by exchanging heat between inside air or outside air of the vehicle and the cold or hot water, and
blow the cold air or the warm air to the front cabin;
a second air conditioning device fluidly connected to the heat pump system and configured to:
receive the cold or hot water from the heat pump system,
provides the cold air or warm air by heat exchange between the inside air or the outside air of the vehicle and the cold or hot water, and
blow the cold air or the warm air to the rear cabin;
a floor heat exchanger mounted in the cabin floor, and fluidly connected to the second air conditioning device, wherein the floor heat exchanger is configured to receive the cold or hot water from the second air conditioning device and configured to cool or heat the cabin floor by circulating the cold or hot water through the cabin floor; and
a line switching valve module disposed between the second air conditioning device and the floor heat exchanger, and configured to send the cold or hot water, which has passed through the second air conditioning device, to the floor heat exchanger, or configured to return the cold or hot water back to the heat pump system,
wherein the cold or hot water, which has circulated through the floor heat exchanger, returns back to the heat pump system.

13. The cabin cooling/heating system of claim 12, further comprising a line addition valve module configured to selectively connect the heat pump system to the second air conditioning device.

14. The cabin cooling/heating system of claim 12, further comprising a water pump module fluidly connected to the heat pump system and configured to pump the cold or hot water in the heat pump system.

15. The cabin cooling/heating system of claim 13, wherein the heat pump system comprises:
a heat pump heat exchanger configured to provide the cold or hot water by allowing water to exchange heat with the refrigerant; and
a heat pump configured to provide the hot water by supplying thermal energy to the water in the heat pump heat exchanger by circulating the refrigerant via a refrigerant circulation line or provide the cold water by recovering thermal energy from the water in the heat pump heat exchanger,
wherein the air conditioning device comprises:
an air passageway configured to allow the inside air or the outside air of the vehicle to communicate with the front cabin, the air passageway defining a passageway through which the inside air or the outside air of the vehicle flows to the front cabin;
an air blower configured to blow the inside air or the outside air of the vehicle into the air passageway;
a heater core disposed in the air passageway and configured to receive the hot water from the heat pump heat exchanger and heat the inside air or the outside air of the vehicle in the air passageway; and
a cooler disposed in the air passageway and configured to receive the cold water from the heat pump heat exchanger and cool the inside air or the outside air of the vehicle in the air passageway,
wherein the second air conditioning device comprises:
a second air passageway configured to allow the inside air or the outside air of the vehicle to communicate with the rear cabin, the second air passageway defining a passageway through which the inside air or the outside air of the vehicle flows to the rear cabin;
a second air blower configured to blow the inside air or the outside air of the vehicle into the second air passageway;
a second heater core disposed in the second air passageway and configured to heat the inside air or the outside air of the vehicle in the second air passageway; and
a second cooler disposed in the second air passageway and configured to cool the inside air or the outside air of the vehicle in the second air passageway,
wherein the line addition valve module comprises:
a first line addition valve configured to selectively connect the heater core to the second heater core to selectively supply the hot water in the heater core to the second heater core; and
a second line addition valve configured to selectively connect the cooler to the second cooler to selectively supply the cold water in the cooler to the second cooler, and
wherein the line switching valve module comprises:
a first line switching valve fluidly connected to the second heater core and configured to receive the hot water from the second heater core and selectively send the hot water to the floor heat exchanger or the heat pump heat exchanger; and
a second line switching valve fluidly connected to the second cooler and configured to receive the cold water from the second cooler and selectively send the cold water to the floor heat exchanger or the heat pump heat exchanger.

16. The cabin cooling/heating system of claim 15, wherein the air conditioning device further comprises an air door configured to selectively open or close the air passageway through which the inside air or the outside air of the vehicle flows to the heater core, and
wherein the second air conditioning device further comprises a second air door configured to selectively open or close the second air passageway through which the inside air or the outside air of the vehicle flows to the second heater core.

17. The cabin cooling/heating system of claim 13, wherein the air conditioning device cools or heats the front cabin in response to an operation of the cabin cooling/heating system,
wherein whether to cool or heat the rear cabin by the second air conditioning device is controlled by the line addition valve module, and
wherein whether to cool or heat the cabin floor by the floor heat exchanger is controlled by the line switching valve module.
